(19) United States
(12) Patent Application Publication
(10) Pub. No.: US 2018/0084945 A1
(43) Pub. Date: Mar. 29, 2018

(54) BARBECUE GRILL AND COOKING METHOD USING BARBECUE GRILL

(71) Applicant: Foods-i Co., Ltd., Hiroshima (JP)

(72) Inventor: Masanori AOYAMA, Hiroshima (JP)

(73) Assignee: Foods-i Co., Ltd., Hiroshima (JP)

(21) Appl. No.: 15/304,363

(22) PCT Filed: Jun. 6, 2016
(86) PCT No.: PCT/JP2016/066814

§ 371 Date: Oct. 14, 2016

(30) Foreign Application Priority Data
Dec. 29, 2015 (JP) 2015-257682

(51) Int. Cl. A47J 37/07; A23L 5/10

(52) U.S. Cl. CPC A47J 37/0754; A23V 2002/00; A23L 5/17; A47J 37/0713

(57) ABSTRACT

Provided is a barbecue grill stably operable even at a low temperature. A barbecue grill grilling a food material includes a gas hose connected with a gas cartridge; a burner portion accommodating a gas burner; a support portion supporting the burner portion; and an oven portion covering the burner portion. The support portion includes a support member; and a support portion space enclosed by the support member. The support portion space accommodates the gas cartridge. The support portion space accommodates a fan, supplying air to the gas cartridge, at a position on the side of the burner portion.

### TECHNICAL FIELD

The present invention relates to a barbecue grill and a cooking method using the barbecue grill, and specifically to a barbecue grill using a gas cartridge as a source of fuel.

The present invention claims the benefit of priority based upon Japanese Patent Application No. 2015-257682 filed on Dec. 29, 2015, the entirety of which is incorporated herein by reference.

### BACKGROUND ART

“Barbecue” refers to cooking meat, fish, vegetables and the like (hereinafter, referred to as “food materials”) outdoors and enjoying the cooked food outdoors. For having a barbecue, food materials (meat, etc.) are put on a gridiron, and the gridiron is heated by a charcoal fire or a gas range. Specifically in Japan, it is considered that heating by a charcoal fire provides the best taste, and barbecue is generally associated with a charcoal fire.

However, it is difficult to do a barbecue with a charcoal fire for a person who is not highly experienced or professional for the following reasons. First, it is time-consuming to make a charcoal fire, and second, it requires a high level of skill to adjust the power of the charcoal fire. The concept that a barbecue should be done by a charcoal fire is considered to be one reason why barbecue is not massively spread in Japan.

In fact, in North America (USA, Canada), which is the home of barbecue, a barbecue is done by a gas burner (gas fire), not by a charcoal fire. The use of a gas fire makes it easy to have a house party every weekend. A gas fire is easy to make, and also the power of the gas fire is easy to adjust. A gas fire does not often cause a cooking failure unlike a charcoal fire, and also realizes an appropriate level of power merely with a dial. A person unexperienced in barbecue often cooks better with a gas fire than with a charcoal fire. An experienced person or a professional has a knack and thus provides a delicious meal with a barbecue grill using a gas fire, like with a barbecue grill using a charcoal fire.

Gas-type barbecue grills are described in, for example, Patent Documents 1 and 2.

FIG. 1 and FIG. 2 show a structure of a barbecue grill 1000 disclosed in Patent Document 1. FIG. 1 is a front view of the barbecue grill 1000, and FIG. 2 is a perspective view of the barbecue grill 1000 as seen from a rear side thereof. The barbecue grill 1000 includes a grill portion 1100, a hood 1200 covering the grill portion 1100, and a propane cylinder 1500 supplying gas to the grill portion 1100.

The barbecue grill 1000 suppresses generation of smoke so that a barbecue is enjoyed in a building or a common house. Specifically, a hose 1300 is attached to the hood 1200, and the hose 1300 is connected with a blower unit 1400. The blower unit 1400 absorbs the generated smoke. The absorbed smoke is processed in a smoke collector formed of a filter 1600.

FIG. 3 and FIG. 4 show a structure of a barbecue grill 2000 disclosed in Patent Document 2. FIG. 3 is a front view of the barbecue grill 2000, and FIG. 4 is a plan view showing a grill portion 2100 of the barbecue grill 2000. The barbecue grill 2000 includes the grill portion 2100, a gridiron 2300 located on the grill portion 2100, and a propane cylinder 1500 supplying gas to the grill portion 2100.

The barbecue grill 2000 includes a fluid circulation tube in the gridiron 2300 in order to prevent meat from being burned or being stuck to the gridiron 2300. A cooling medium is supplied to flow in the fluid circulation tube in the gridiron 2300 so that the gridiron 2300 is cooled.

### CITATION LIST

### Patent Document

Patent Document 1: Japanese Patent Laid-Open Publication No. 2014-54508

Patent Document 2: Japanese Patent No. 4575960

### SUMMARY OF THE INVENTION

### Technical Problem

The barbecue grill 1000 in Patent Document 1 and the barbecue grill 2000 in Patent Document 2 each include elements embodying good ideas. However, according to the studies made by the present inventor, such ideas actually decline the performance of the respective barbecue cooking devices (barbecue grills). The present inventor has determined that the barbecue cooking devices including the elements embodying these ideas do not massively spread barbecue.

First, the barbecue grill 1000 in Patent Document 1 absorbs a high temperature atmosphere (heated air) in the hood 1200 by the hose 1300, and therefore has a problem that meat is not heated in a preferable state. A key in grilling meat in a barbecue cooking device is, in fact, heating in a sealed state by the hood 1200. Meat is made delicious by being heated at a high temperature in a sealed state in the hood 1200. In actuality, the taste of meat is more influenced by whether the meat is heated in such a sealed state by the hood 1200 or not rather than by whether a charcoal fire is used or a gas fire is used. The barbecue grill 1000 in Patent Document 1 absorbs the high temperature atmosphere in the hood 1200 by the hose 1300 in order to eliminate smoke. Therefore, it is difficult to grill delicious meat.

The barbecue grill 2000 in Patent Document 2 has a function of cooling the gridiron 2300 in order to prevent meat from being stuck to the gridiron 2300. This decreases the temperature in the vicinity of the gridiron 2300 and thus highly possibly makes it difficult to grill delicious meat.

As a result of making studies, the present inventor has noticed that a factor preventing barbecue from being spread is not the generation of smoke or meat being stuck to a gridiron, but is a propane cylinder used for a movable barbecue cooking device (barbecue grill). A barbecue is done outdoors and thus a barbecue cooking device needs to be movable. Such a movable barbecue cooking device requires a propane cylinder (1500) as a source of fuel.

In North America (USA, Canada), which is the home of barbecue, the portable propane cylinder 1500 is prepared in many houses for having a house party, or going camping or going on a picnic. The people are accustomed to using the propane cylinder 1500. By contrast, in Japan, a barbecue at home or at a camp or picnic site is not a daily event but is something special. The people do not feel comfortable connecting the propane cylinder 1500 to a movable barbecue cooking device. Such uncomfortableness causes the people to use a charcoal fire for a barbecue, and the difficulty in using a charcoal fire prevents the people from doing a barbecue often. This is a vicious cycle.

In the case where a propane cylinder is used, the propane cylinder needs to be supplemented with propane gas by a propane gas company before each barbecue in order to avoid a situation where the barbecue grill is short of propane gas in the middle of the barbecue. The number of propane gas companies is smaller than the number of convenience stores or DIY stores. The user often needs to visit a propane gas company far from home for having the propane cylinder supplemented with propane gas. In addition, propane gas costs relatively high (as compared with city gas or the like). Moreover, the user is charged for the propane gas in accordance with the capacity of the propane cylinder regardless of whether there is an amount of propane gas left or not before the supplement and thus may pay more than the cost of the actually supplied amount.

The present inventor has conceived that barbecue will be massively spread if a barbecue cooking device (barbecue grill) is operated by a gas cartridge (gas container usable for a portable oven), which is common in Japan, instead of the propane cylinder (1500). While continuing the studies on this idea, the present inventor found a serious problem of a gas cartridge, which did not occur with the propane cylinder (1500). However, the present inventor continued to make improvements and perform experiments, and succeeded in overcoming the problem. Thus, the present inventor successfully developed a barbecue cooking device (barbecue grill) safely operable using a gas cartridge.

The present invention made in light of the above-described situation has a main object of providing a barbecue grill safely operable even at a low temperature.

### Solution to the Problem

A barbecue grill according to the present invention is a barbecue grill grilling a food material. The barbecue grill includes a gas hose connected with a gas cartridge filled with liquefied butane containing normal butane as a main component; a burner portion accommodating a gas burner burning gas supplied through the gas hose; a support portion located below the burner portion, the support portion supporting the burner portion; and an oven portion located above the burner portion, the oven portion covering the burner portion. The support portion includes a support member securing the burner portion; and a support portion space enclosed by the support member. The support portion space accommodates the gas cartridge; and a fan supplying air to the gas cartridge is located at a position on the side of the burner portion in the support portion space.

In a preferable embodiment, the fan is a battery-driven ventilator; and the support portion space is a closed space enclosed by the support member.

In a preferable embodiment, the gas cartridge is set in a gas cartridge unit allowing a plurality of the gas cartridges to be accommodated therein; the gas hose is connected with the gas cartridge unit; and the fan is located above the gas cartridge unit.

In a preferable embodiment, a second fan supplying air to the gas cartridge is located below the gas cartridge in the support portion space.

In a preferable embodiment, an air guiding member allowing air to be supplied to the second fan by ventilation of the fan is located in the support portion space.

In a preferable embodiment, the support member enclosing the support portion space includes a metal plate and a door portion.

In a preferable embodiment, the support member is connected with a base table provided with a wheel; a propane cylinder accommodation portion allowing a propane cylinder to be set therein is provided in the base table; the burner portion accommodates a plurality of the gas burners; a gridiron on which the food material is to be placed is provided above the burner portion; the gridiron is put into a sealed state by being covered with the oven portion; the oven portion has a thermometer attached thereto, the thermometer indicating an inner temperature of the oven portion; the burner portion including the gridiron is connected with a side table; and the fan and the gas cartridge are located on a rack provided in the support portion space.

A cooking method according to the present invention is a cooking method using a barbecue grill. The barbecue grill is a burning device burning gas from a gas cartridge filled with liquefied butane. The method includes the steps of burning the gas by the barbecue grill; heating a food material by the burning; and blowing air heated by the burning toward the gas cartridge cooled by a heat of vaporization.

In a preferable embodiment, the barbecue grill includes a burner portion including a gas burner burning the gas; in the step of blowing, the air heated by the burning is located below the burner portion; and the heated air is caused to hit the gas cartridge by a fan.

In a preferable embodiment, a closed space enclosed by a support member is located below the burner portion; the gas cartridge is located in the closed space; and the heated air moves in the closed space to contact the gas cartridge.

In a preferable embodiment, the step of blowing is performed by a first fan located above the gas cartridge and a second fan located below the gas cartridge.

In a preferable embodiment, the gas cartridge is filled with liquefied butane containing normal butane as a main component; the gas cartridge is set in a gas cartridge unit allowing a plurality of the gas cartridges to be accommodated therein; and in the step of burning the gas by the barbecue grill, the gas is supplied to the barbecue grill from the gas cartridge unit via a gas hose.

A heating cooking device according to the present invention is a heating cooking device grilling a food material. The heating cooking device includes a gas cartridge unit accommodating a gas cartridge filled with liquefied butane; a burner portion located above the gas cartridge unit, the burner portion burning gas vaporized from the liquefied butane; and a support portion located below the burner portion, the support portion supporting the burner portion. A fan is located between the burner portion and the gas cartridge unit.

In a preferable embodiment, the support portion includes an air-blocking member; and the gas cartridge unit and the fan are enclosed by the air-blocking member.

In a preferable embodiment, a second fan is located below the gas cartridge unit.

In a preferable embodiment, the fan is an absorbing fan absorbing air in the vicinity thereof; and the fan is provided with a duct allowing the absorbed air to be supplied to the second fan.

In a preferable embodiment, the fan is a ventilator blowing air toward the gas cartridge unit and supplying the air to the second fan.

A gas cartridge box according to the present invention is a gas cartridge box including a gas cartridge. The gas cartridge box includes a gas cartridge unit accommodating a gas cartridge filled with liquefied butane; a fan located above the gas cartridge unit; and a housing accommodating the gas cartridge unit. The fan is located on a top surface of the housing.

In a preferable embodiment, the gas cartridge unit is connected with a gas hose allowing gas from the gas cartridge to flow therein; the housing has a structure closing the gas cartridge unit; the fan is a ventilator blowing air located above the housing toward the gas cartridge unit; and the gas hose extends to the outside of the housing.

A method for producing a grilled product according to the present invention is a method for producing a grilled product by burning gas. The method includes the steps of burning, by a gas burner, gas supplied from a gas cartridge filled with liquefied butane; heating a heating target by the burning by the gas burner; and blowing air heated by the burning toward the gas cartridge cooled by a heat of vaporization.

In a preferable embodiment, in the step of blowing, the air heated by the burning is located below the gas burner; and the heated air is caused to hit the gas cartridge by a fan; and an air-blocking member is located in the vicinity of the gas cartridge.

A barbecue grill in an embodiment according to the present invention is a barbecue grill grilling a food material. The barbecue grill includes a burner portion accommodating a gas burner burning gas supplied from a gas cartridge filled with liquefied butane; and a support portion located below the burner portion, the support portion supporting the burner portion. The support portion includes a support member securing the burner portion; and a support portion space enclosed by the support member. The gas cartridge is accommodated in the support portion space, and a fan supplying air to the gas cartridge is located at a position on the side of the burner portion in the support portion space.

In a preferable embodiment, the fan is a battery-driven ventilator; and the support portion space is a closed space enclosed by the support member.

In a preferable embodiment, the gas cartridge is set in a gas cartridge unit allowing a plurality of the gas cartridges to be accommodated therein; the gas cartridge unit is connected with the burner portion via the gas hose; and the fan is located above the gas cartridge unit.

In a preferable embodiment, a second fan supplying air to a bottom surface of the gas cartridge is located below the gas cartridge.

In a preferable embodiment, an air guiding member allowing air to be supplied to the second fan by ventilation of the fan is located in the support portion space.

In a preferable embodiment, the support member enclosing the support portion space includes a metal plate and a door portion.

A heating cooking device in an embodiment according to the present invention is a heating cooking device grilling a food material. The heating cooking device includes a gas cartridge unit accommodating a gas cartridge; and a burner portion located above the gas cartridge unit. A fan blowing air toward the gas cartridge unit is located below the burner portion.

In a preferable embodiment, the fan is located between the burner portion and the gas cartridge unit.

In a preferable embodiment, the fan is a ventilator blowing air toward a bottom surface of the gas cartridge unit.

In a preferable embodiment, a support portion supporting the burner portion is located below the burner portion; the support portion includes an air blocking member; and the gas cartridge unit and the fan are enclosed by the air blocking member.

In a preferable embodiment, a first fan is located above the gas cartridge unit; and a second fan is located below the gas cartridge unit.

In a preferable embodiment, the first fan is an absorbing fan absorbing air in the vicinity thereof; and the first fan is provided with a duct allowing the absorbed air to be supplied to the second fan.

A gas cartridge box in an embodiment according to the present invention is a gas cartridge box including a gas cartridge. The gas cartridge box includes a gas cartridge unit accommodating a gas cartridge filled with liquefied butane; a fan located above the gas cartridge unit; and a housing accommodating the gas cartridge unit. The fan is located on a top surface of the housing.

In a preferable embodiment, the gas cartridge unit is connected with a gas hose allowing gas from the gas cartridge to flow therein; the housing has a structure closing the gas cartridge unit; the fan is a ventilator blowing air located above the housing toward the gas cartridge unit; and the gas hose extends to the outside of the housing.

A gas cartridge box in an embodiment according to the present invention is a gas cartridge box including a gas cartridge. The gas cartridge box includes a gas cartridge unit accommodating a gas cartridge filled with liquefied butane; and a housing accommodating the gas cartridge unit. A fan blowing air toward a bottom surface of the gas cartridge is located in the housing.

A gas cartridge box in an embodiment according to the present invention is a gas cartridge box including a gas cartridge. The gas cartridge box includes a gas cartridge unit accommodating a gas cartridge filled with liquefied butane; and a housing accommodating the gas cartridge unit. A heater increasing a temperature of air inside the housing is located in the housing; and a fan circulating the air heated by the heater is located in the housing.

In a preferable embodiment, the housing forms a sealed space; and the heater is provided with a thermostat controlling the temperature.

### Advantageous Effects of Invention

In a barbecue grill according to the present invention, a gas cartridge is accommodated in a support portion space in a support portion supporting a burner portion accommodating a gas burner. A fan is located at a position on the burner portion side in the support portion space. Therefore, air heated by the gas burner is caused to hit the gas cartridge by a fan. Thus, the temperature of the gas cartridge cooled by a heat of vaporization caused by release of butane gas is increased. As a result, the barbecue grill using the gas cartridge filled with liquefied butane is stably operable even in an environment with a low temperature (e.g., in winter or at night).

This will be described more specifically. Propane filling a propane cylinder has a boiling point of −42° C. and a high steam pressure. Therefore, the propane cylinder releases gas in a preferable manner even in a cold environment. A gas cartridge filled with liquefied butane has a lower ability of releasing gas in a cold environment such as in winter or at night because normal butane has a boiling point of −0.5° C. and a low steam pressure. Naturally, the gas cartridge filled with normal butane is not usable at a temperature of −0.5° C. or lower. Even at a higher temperature, the gas cartridge is cooled by a heat of vaporization of gas. Therefore, the gas cartridge does not release gas or, even if the gas is released, the amount of gas that is released is significantly smaller. Such a gas cartridge is not usable for cooking or grilling at a barbecue. In the barbecue grill according to the present invention, air heated by the gas burner is blown toward the gas cartridge cooled by a heat of vaporization. Therefore, the temperature of the gas cartridge is made appropriate, and thus a preferable amount of gas is released. Even at a site with a low temperature, cooking and burning at a barbecue is performed in a preferable manner.

### BRIEF DESCRIPTION OF THE DRAWINGS

FIG. 1 is a front view showing a structure of a barbecue grill 1000 described in Patent Document 1.

FIG. 2 is a perspective view, as seen from a rear side, showing the structure of the barbecue grill 1000 described in Patent Document 1.

FIG. 3 is a front view showing a structure of a barbecue grill 2000 described in Patent Document 2.

FIG. 4 is a plan view showing the structure of the barbecue grill 2000 described in Patent Document 2.

FIG. 5 is a perspective view of a barbecue grill 3000 studied by the present inventor.

FIG. 6 is a front view of the barbecue grill 3000 studied by the present inventor.

FIG. 7 is a perspective view showing a use state of the barbecue grill 3000.

FIG. 8 is a perspective view, as seen from a front side, of a barbecue grill 3500 studied by the present inventor.

FIG. 9 is a perspective view of a gas cartridge unit 50.

FIG. 10 is a perspective view of a gas cartridge 52.

FIG. 11 is a perspective view of a gas cartridge unit.

FIG. 12 is a perspective view of a portable oven 4000.

FIG. 13 is a schematic cross-sectional view showing a heat panel of the portable oven 4000.

FIG. 14 is a front view showing a barbecue grill 100 in an embodiment according to the present invention.

FIG. 15 is a perspective view showing a fan 21.

FIG. 16 is a perspective view showing a fan 21.

FIG. 17 is a front view showing a modification of the barbecue grill 100 in an embodiment according to the present invention.

FIG. 18 is a front view showing a modification of the barbecue grill 100 in an embodiment according to the present invention.

FIG. 19 is a perspective view showing a barbecue grill 100 in an embodiment according to the present invention.

FIG. 20 is a perspective view showing a modification of the barbecue grill 100 in an embodiment according to the present invention.

FIG. 21 is a perspective view showing a modification of the barbecue grill 100 in an embodiment according to the present invention.

FIG. 22 is a perspective view showing a barbecue grill 100 in an embodiment according to the present invention.

FIG. 23 is a perspective view showing a gas cartridge box 150 in an embodiment according to the present invention.

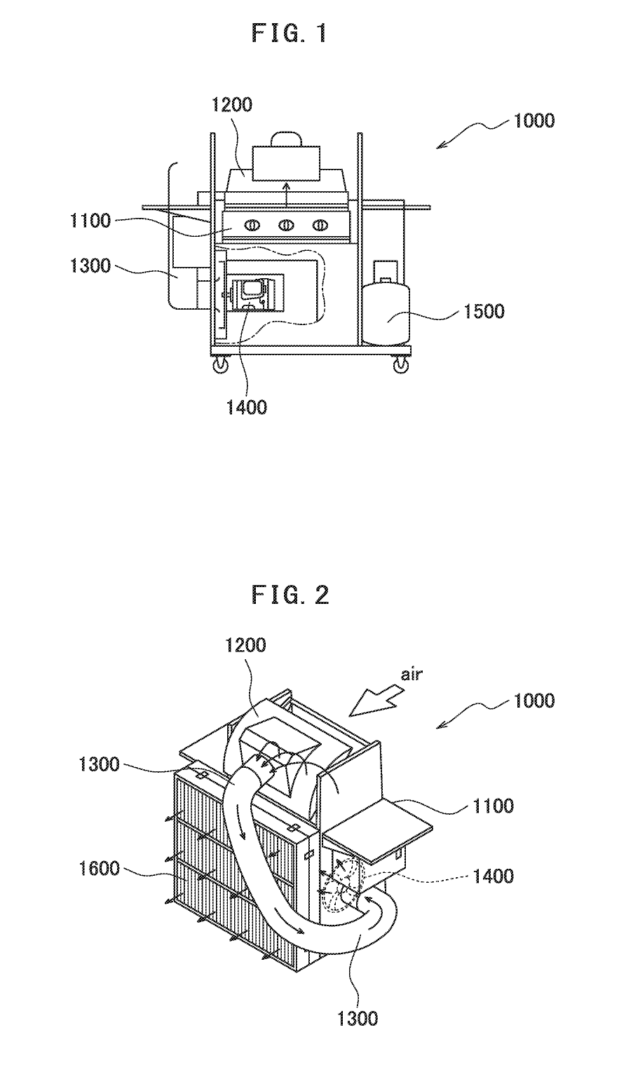

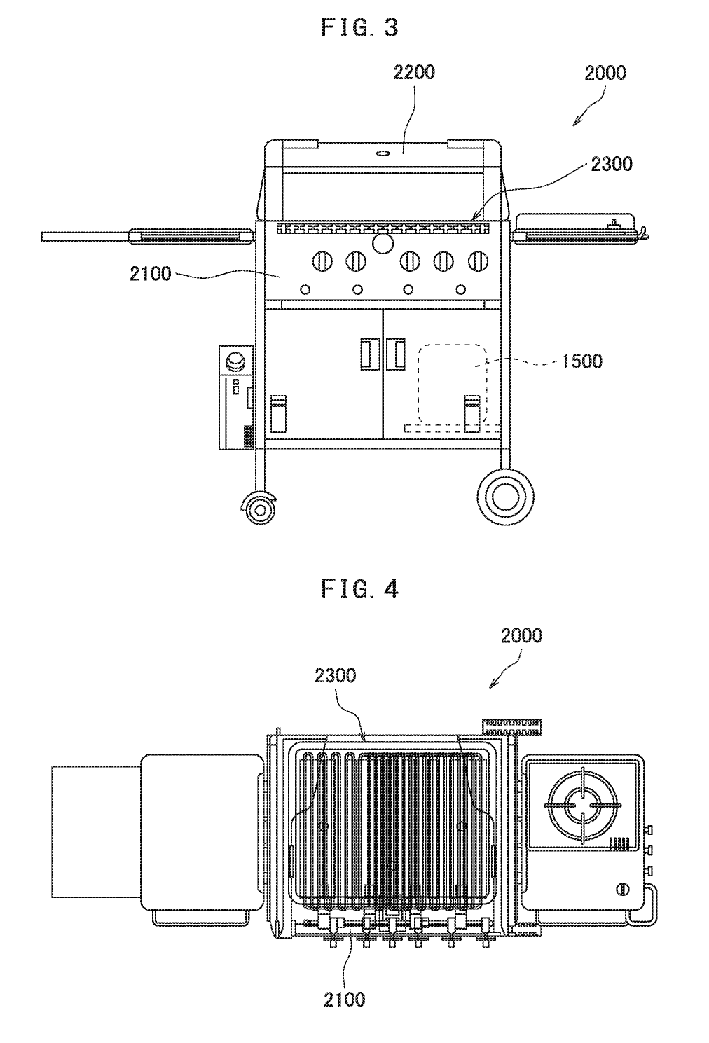

### DESCRIPTION OF EMBODIMENTS

Before describing embodiments of the present invention, the studies made by the present inventor will be described. Then, embodiments according to the present invention will be described.

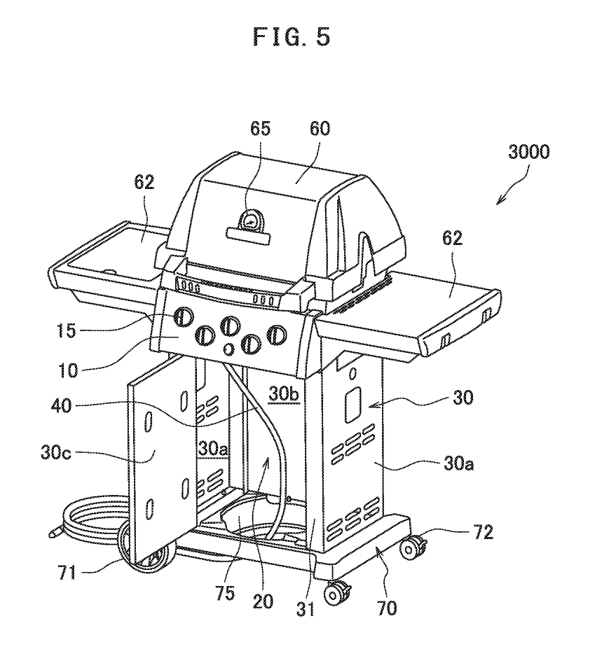

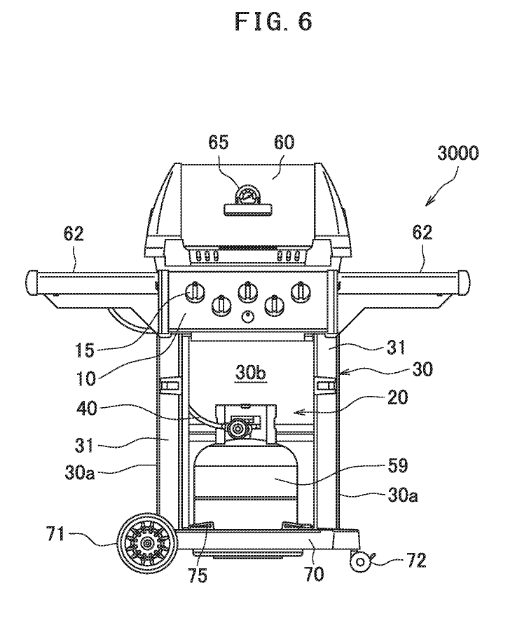

FIG. 5 and FIG. 6 show a barbecue grill 3000 studied by the present inventor. The barbecue grill 3000 includes a burner portion 10 accommodating a gas burner (not shown), a support portion 30 supporting the burner portion 10, and an oven portion 60 covering the burner portion 10. The burner portion 10 has a fire power dial 15 attached thereto. The fire power dial 15 is usable to adjust the amount of gas. The burner portion 10 has a gridiron (not shown) located on a top surface thereof. On the gridiron, a food material (meat, etc.) is to be located and grilled. Side tables 62 are attached to both of two sides of the gridiron. The oven portion 60 has a thermometer 65 attached thereto. The thermometer 65 shows an inner temperature of the oven portion 60. In the case where the burner portion 10 (gridiron) is covered with the oven portion 60 while the gas burner is an in ON state, a food material is steamed at a high temperature in the oven portion. In this case, the temperature may be 200° C. or higher. Steaming at such a high temperature is a key to the deliciousness of barbecued food material.

The support portion 30 includes support members 31 (30a, 30b and 30c), which include side surface portions (side plates) 30a, a rear surface portion (rear plate) 30b, and a front door portion (door plate) 30c. As shown in FIG. 6, in a support portion space 20 enclosed by the support members 31, a propane cylinder 59 may be set. A gas hose 40 is connected with the propane cylinder 59, and the gas hose 40 is connected with the burner portion 10. With such an arrangement, propane gas in the propane cylinder 59 is supplied to the gas burner 12, and the fire power dial 15 is operated to adjust burning of the gas.

The support portion 30 (support members 31) is provided on a base table 70. The base table 70 has a propane cylinder accommodation portion 75 provided therein. The propane cylinder 59 may be set in the propane cylinder accommodation portion 75. The base table 70 has a moving wheel 71 and a fixing wheel 72 attached thereto. The wheels 71 and 72 attached to the base table 70 allow the barbecue grill 3000 to be put on the ground and movable on the ground. The fixing wheel 72 may be switched on or off to put the barbecue grill 3000 into a fixed state in which the barbecue grill 3000 is not movable or a movable state.

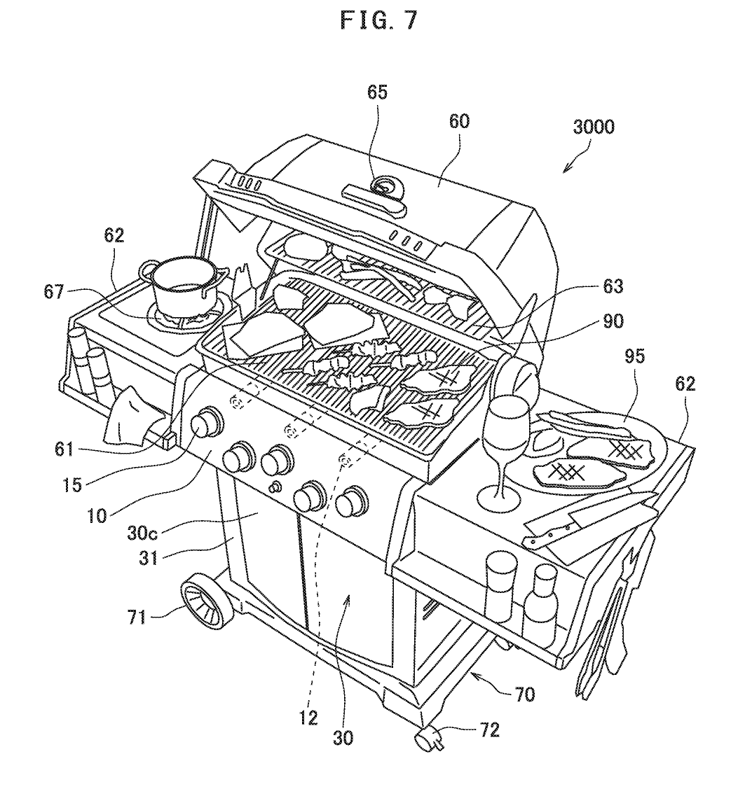

FIG. 7 shows the barbecue grill 3000 in an operating state (heating state, cooking state). When a gas burner 12 accommodated in the burner portion 10 is turned on, a gas fire rises toward a gridiron (food material placing portion) 61 located above the gas burner 12. On the gridiron 61, a food material (meat, etc.) 90 is placed and may be cooked (grilled) by the gas fire. Inside the oven portion 60, a second gridiron (food material placing portion) 63 is provided. On the second gridiron 63, a grilled food material may be placed, a food material that is not wished to be grilled too much may be placed, or a food material to be steamed in the oven portion 60 may be placed.

On the side tables 62, a kitchen item (barbecue item) 95 such as a plate, a glass or the like may be placed. With such an arrangement, the barbecue grill 3000 may be used as a kitchen providing a meal in addition to having a gas burner function. In the case where a portable oven 67 is placed on one of the side tables 62, a pot or a kettle may be placed thereon so that cooking other than grilling may be done. The portable oven 67 also burns the gas in the propane cylinder 59 accommodated in the support portion 30.

In North America (USA, Canada), which is the home of barbecue, gas-type barbecue grills occupy 70 to 80% of the market, and charcoal fire-type barbecue grills are less common. Since the gas-type barbecue grills are common, propane cylinders 59 are commonly prepared in many houses of the people enjoying a barbecue. These people are accustomed to using the propane cylinder 59 and also accustomed to setting the gas hose 40 and opening/closing the propane cylinder 59.

Since there are many cold regions in North America (USA, Canada), a propane cylinder filled with liquefied propane is convenient. More specifically, propane (C₃H₈) has a boiling point of −42.09° C. and a steam pressure of 8513 (hPa, 20° C.) (burning energy: 44.0 KJ/g). Since the boiling point of propane is thus low, the barbecue grill 3000 is operable in a preferable manner by a propane cylinder even at temperature below zero.

By contrast, it is generally warmer in Japan than in such cold regions in North America, and a gas fire is often used indoors, not outdoors. Therefore, a gas cartridge is common instead of a propane cylinder. Gas cartridges, which are readily available at convenience stores, supermarkets, DIY stores and many other stores, are convenient. A gas cartridge is filled with liquefied butane (normal butane, i.e., n-butane). Normal butane (C₄H₁₀) has a boiling point of −0.5° C. and a steam pressure of 2213 (hPa, 20° C.) (burning energy: 42.8 KJ/g).

Namely, normal butane has a higher boiling point than propane, and is not usable in principle at a temperature lower than −0.5° C. because liquefied butane is not vaporized at such a temperature. In addition, when liquefied butane is vaporized, a heat of vaporization is taken therefrom. This cools the gas cartridge. At a temperature of about 10° C. or lower, the amount of gas supplied from the gas cartridge is decreased, and thus it is difficult to use the gas cartridge for a barbecue.

As a gas cartridge having specifications for use in a cold region, a gas cylinder filled with iso-butane instead of normal butane (high power (cold region) gas cartridge) is on the market. Iso-butane (C₄H₁₀) has a boiling point of −11.7° C. and a steam pressure of 3113 (hPa, 20° C.) (burning energy: 42.8 KJ/g). Iso-butane, which has a boiling point of −11.7° C., is usable to operate the barbecue grill 3000 even at a temperature around 0° C.

However, the boiling point of iso-butane is higher than the boiling point of propane, which is −42° C. Therefore, propane is burned better in a cold region. The steam pressure of iso-butane is higher than the steam pressure of normal butane. Therefore, at the same capacitance, iso-butane is consumed faster than normal butane. In addition, a gas cartridge of iso-butane (high power) costs higher than a gas cartridge of normal butane (normal power). Iso-butane is not economical from the points of view of the amount to be consumed and the cost.

For the above-described reasons, it is most preferable to use propane gas in the propane cylinder 59 as combustion gas for the barbecue grill 3000. However, the gas cylinder 59 has the following problems. In Japan, propane cylinders are not common. Therefore, many people do not know how to handle, and thus do not wish to purchase or use, a propane cylinder. A person working in a stall, a restaurant or the like is accustomed to handling a propane cylinder and thus feels no problem. However, a general layperson is not accustomed to, and thus does not feel comfortable, handling a propane cylinder. Even such a person is accustomed to handling a gas cartridge and knows the safety and the danger thereof, and thus does not wish to take the trouble of handling a propane cylinder in the state where a gas cartridge is available.

A propane cylinder does not cost less than a gas cartridge. The cost of propane is not much different from the cost of the gas in the gas cartridge. However, a user of a propane cylinder needs to visit a propane gas company to have the propane cylinder supplemented, and also is charged for the supplement. Since the propane gas companies are not located everywhere, visiting such a company is costly and time-consuming. By contrast, a gas cartridge is disposable and a user thereof does not pay for the supplement. A gas cartridge is available everywhere, and a barbecue grill is not short of gas if a plurality of gas cartridges are prepared. These factors motivate a person to use a gas cartridge but not a barbecue grill requiring a propane cylinder. The present inventor has considered that barbecue grills will not be massively spread unless this vicious cycle is solved.

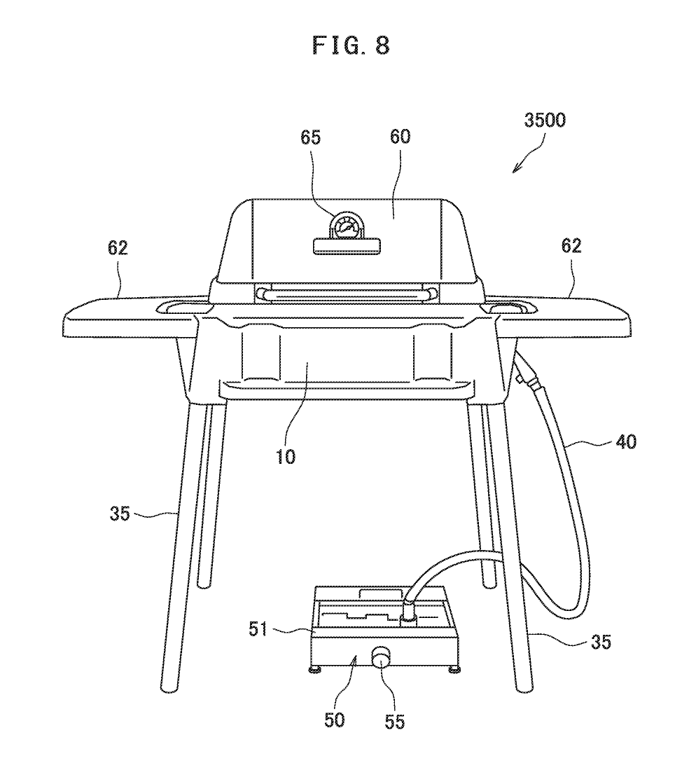

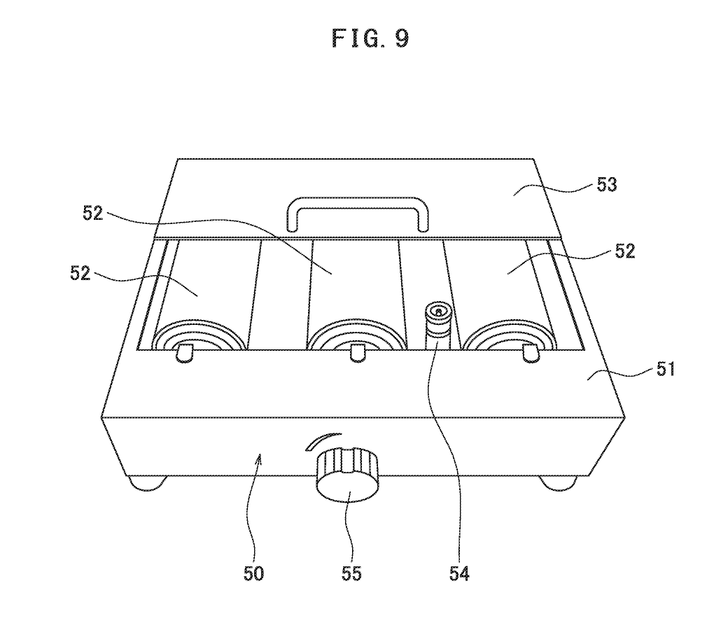

While making such studies, the present inventor connected a gas cartridge unit 50 to a barbecue grill 3500 shown in FIG. 8 to perform barbecue cooking by use of a gas cartridge filled with normal butane. The burner portion 10 of the barbecue grill 3500 is supported by support rods 35. The gas cartridge unit 50 has a structure shown in FIG. 9.

The gas cartridge unit 50 includes a housing 51 accommodating a gas cartridge 52. The gas cartridge unit 50 shown in FIG. 9 allows a plurality of (three in this example) gas cartridges 52 to be set in the housing 51. When being set, the gas cartridges 52 are secured in the housing 51 by a cover 53, and gas is released through a gas exit 54. The gas exit 54 is to be connected with the gas hose 40. The housing 51 has a gas amount adjusting dial 55 provided thereon. When the dial 55 is put to zero, the amount of gas that is released is made zero even in the state where the gas cartridges 52 are set in the housing 51. Thus, the gas cartridge unit 50 is safe.

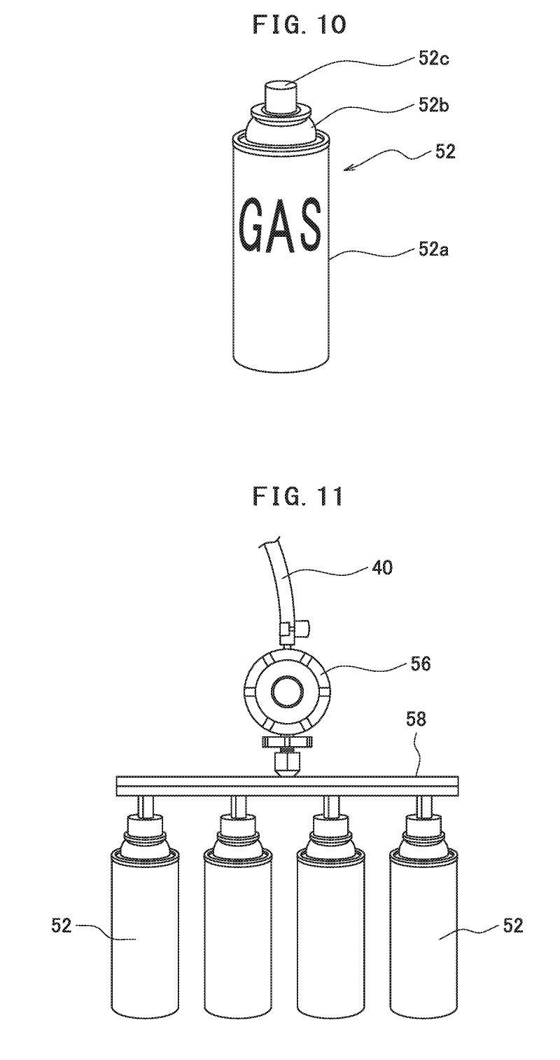

The gas cartridges 52 each have a structure shown in FIG. 10. Each gas cartridge 52 contains liquefied gas (n-butane (straight chain butane) or in some cases, iso-butane (2-methylpropane) sealed in a tube main body 52a. A tip portion 52b attached to the tube main body 52a has a gas ejection opening (nozzle). When the gas cartridge 52 is not in use, the gas ejection opening is covered with a cap 52c. The tip portion 52b has a structure corresponding to a set portion of a portable oven (special shape including a cut-out portion) so that the gas cartridge 52 is easily set in the portable oven.

The gas cylinder unit 50 shown in FIG. 9 includes the housing 51. Alternatively, a gas cylinder unit using the gas cartridges 52 may have a structure shown in FIG. 11. The gas cylinder unit shown in FIG. 11 includes a coupling portion 58 coupling a plurality of the gas cylinders 52 and a gas hose connection portion 56 attached to the coupling portion 58. The gas hose connection portion 56 is connected with the gas hose 40. A gas flow rate adjusting valve may be attached to the gas hose connection portion 56.

The present inventor operated the barbecue grill 3500 shown in FIG. 8. In summer, when the outdoor temperature was high (or during the daytime, when the temperature was high), the barbecue grill 3500 was operated with no problem. However, when the outdoor temperature was, for example, about 10° C. (or lower than 15° C. to 10° C.), the amount of gas released from the gas cartridges 52 was decreased, and it was difficult to do a barbecue in a preferable manner. A barbecue provides a meal, and therefore, it is not sufficient that a food material (90) is merely heated. Unless a predetermined amount of heat is provided within a short time, the meal is not delicious and the barbecue results in a failure. Especially, when meat is heated for a long time for the reason that the power of the fire is low, the meat is made tough. Even meat of a highest quality tastes bad. In such a case, the barbecue is disastrous.

A tabletop portable oven, instead of the barbecue grill 3500, includes an element called a “heat panel (heat transmitting member)”, which prevents the temperature of the gas cartridges from decreasing.

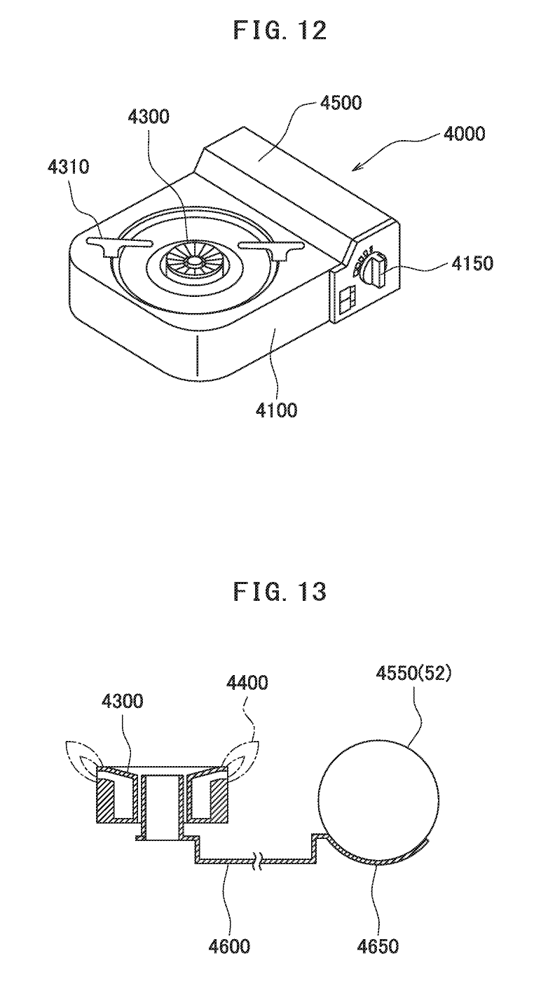

FIG. 12 and FIG. 13 show a structure of a tabletop portable oven 4000. As shown in FIG. 12, the tabletop portable oven 4000 includes a housing 4100 accommodating an oven 4300 and a gas cartridge accommodation portion 4500. The housing 4100 has support portions 4310 provided around the oven 4300. The support portions 4100 support a pot, a frying pan or the like. The housing 4100 has a gas output adjusting dial 4150 provided on a side surface thereof on the side of the gas cartridge accommodation portion 4500.

As shown in FIG. 13, a gas cartridge 4550 (52) is set in the gas cartridge accommodation portion 4500. When a gas fire 4400 is made by the oven 4300, the heat of the fire is transmitted through a heat transmitting member 4600 to a holder (heat transmitting member) 4650 holding a bottom surface of the gas cartridge 4550 (52). Thus, the fire heats the gas cartridge 4550 (52). In this manner, the gas cartridge is prevented from being decreased in the temperature by a heat of vaporization, and thus the amount of gas ejected from the gas cartridge is suppressed from being decreased.

The tabletop portable oven 4000 may have a member such as a heat panel (the heat transmitting member 4600 or 4650) attached thereto. In the case of the barbecue grill 3500 shown in FIG. 8, it is not realistic to attach such a heat panel for the following reasons. First, the gas burner (12) of the burner portion 10 and the gas cartridge unit 50 (gas cartridges 52) are too far from each other to transmit heat therebetween by a heat transmitting member. Second, the gas cartridges 52 are not set in the burner portion 10 and thus the heat transmitting member is not easily located.

Even if the gas cartridges 52 are set in the burner portion 10 and heated by the heat transmitting member (heat panel), there may occur a problem that the gas cartridges 52 are excessively heated. In the case of the barbecue grill 3500, unlike in the case of the tabletop portable oven 4000, the amount of heat used to do a barbecue is large. Therefore, the barbecue grill 3500 tends to generate a larger amount of heat than the tabletop portable oven 4000. In this case, the mechanism of the heat panel that is suitable to the tabletop portable oven 4000 may cause the gas cartridges 52 to be heated excessively in the barbecue grill 3500. Such excessive heating of the gas cartridges 52 is not preferable for a safety reason and should be avoided.

Next, the present inventor conceived wrapping the gas cartridges 52 used for the barbecue grill 3500 with a warm and heat-insulating member such as a blanket or the like in order to prevent the temperature of the gas cartridges 52 from being decreased. However, the gas cartridges 52 are not cooled by the outdoor temperature, but is cooled to a temperature lower than the outdoor temperature (or room temperature) by a heat of vaporization when the liquid in the gas cartridges 52 is changed to gas. Thus, it is meaningless to wrap the gas cartridges 52 with the member such as a blanket or the like.

Next, the present inventor conceived heating the cooled gas cartridges 52 by an electric heater. However, use of an electric heater requires an electric outlet, and it decreases the convenience and thus is not preferable to provide an electric outlet in the barbecue grill 3500, which is often used outdoors. If the electric outlet is not to be used, it is conceivable to use an electric heater operable by batteries. However, heating by electricity consumes a larger amount of energy (than an electric control operation or the like), and thus requires a large number of batteries. This is not efficient or economical.

As a heating method not using an electric outlet or batteries, the present inventor studied using a disposable heat pack based on the heat generation principle of oxidation reaction of iron. However, the disposable heat pack reaches a temperature of about 60° C. (highest temperature: 63° C.; average temperature: 53° C.; heating duration: 10 hours), which excessively heats the gas cartridges 52. The gas cartridges 52 are required to be kept at a temperature of 40° C. or lower, and it is not preferable to heat the gas cartridges 52 to a temperature of about 60° C. or higher. The disposable heat pack has a heating duration of 10 hours or longer, which is significantly longer than the time duration in which the barbecue grill 3500 is used or the gas cartridges 52 are used. This causes time mismatch.

It is conceivable to use a heat pack not disposable (e.g., warm water-type, heated stone-type, platinum catalyst-type heat pack, etc.). However, a user wishes to do a barbecue and does not take the trouble of preparing such a heat pack in order to prevent the temperature of the gas cartridges 52 from being decreased. In actuality, the user does not wish to use the barbecue grill 3500 using the gas cartridges 52 if such a trouble needs to be taken.

In such a situation, the present inventor conceived using the air heated by the heat generated by the burner portion 10 (gas burner 12) of the barbecue grill 3500 to prevent the gas cartridges 52 from being cooled. Using the barbecue grill 3500 having the structure shown in FIG. 8, the present inventors caused the air located just below the burner portion 10 (heated air) to be blown toward the gas cartridges 52 by a fan (ventilator). However, the distance to the gas cartridges 52 was too long to heat the gas cartridges 52 (to prevent the gas cartridges 52 from being cooled).

The present inventor almost concluded that the gas cartridges 52 were not prevented from being cooled as a result of performing various studies. However, when locating the gas cartridge unit 50, instead of the propane cylinder 59, in the support portion space 20 of the barbecue grill 3000 shown in FIG. 5 and locating a fan at a position above the gas cartridge unit 50 and below the burner portion 10, the present inventor found that the air from the fan prevented the gas cartridges 52 from being cooled. Specifically, the support members 31 (30a, 30b and 30c) included in the support portion 30 acted as air-blocking members, and the air heated just below the burner portion 10 was put into contact with the gas cartridges 52 in a preferable manner by the fan (ventilator). In the state where the door portion 30c, among the support members, was open, the gas cartridges 52 were suppressed from being cooled. Therefore, it has been found that as long as the support portion space 20 is closed on at least three sides (e.g., the left and right sides and the rear side), the flow of the air (entrance and exit of the air) is stopped and a heating effect by the fan (ventilator) (effect of preventing the gas cartridges 52 from being cooled) is provided. The support members 31 (30a, 30b and 30c) of the barbecue grill 3000 shown in FIG. 5 are provided to conceal the propane cylinder 59, and are not originally air-blocking members.

Based on the knowledge of this success, the present inventor conceived and completed a barbecue grill stably supplying gas even in a cold region with a low temperature while using gas cartridges. Hereinafter, preferable embodiments of the present invention will be described with reference to the drawings. In the following drawings, elements or sites having the same function will have the same reference signs, and overlapping descriptions may be omitted or simplified for the sake of simplicity. In the drawings, the relative sizes (length, width, thickness, etc.) may not accurately reflect the actual relative sizes.

Elements that are other than elements specifically referred to in this specification and are necessary to carry out the present invention may be grasped as a matter of design choice for a person of ordinary skill in the art based on the conventional technology in the art. The present invention may be carried out based on the contents disclosed by this specification and the attached drawings, and the technological common knowledge in the art. The present invention is not limited to any of the following embodiments.

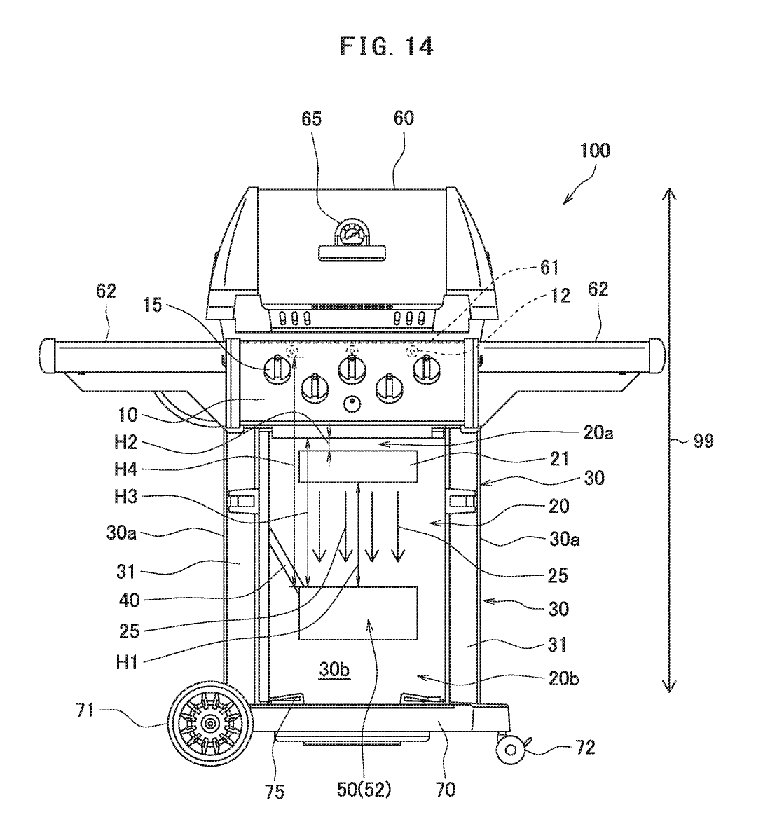

FIG. 14 shows a structure of a barbecue grill 100 in an embodiment according to the present invention. The barbecue grill (heating cooking device) 100 in this embodiment is a heating cooking device (heating device, oven) performing heating by use of gas provided from the gas cartridges 52, and grills a food material. The manner of (or the elements required for) grilling or cooking a food material (90) is substantially the same that shown in FIG. 7. In FIG. 14, arrow 99 represents the vertical direction (upward/downward direction).

The barbecue grill 100 in this embodiment includes a burner portion 10 accommodating the gas burner 12 burning gas and a support portion 30 supporting the burner portion 10. The support portion 30 is located below the burner portion 10 and includes support members 31. The barbecue grill 100 includes an oven portion 60 located above the burner portion 10 to cover the burner portion 10.

The support portion 30 in this embodiment includes the support members 31 securing the burner portion 10 and a support portion space 20 enclosed by the support members 31. The support portion space 20 is a closed space enclosed by air-blocking members 31 (30a, 30b and 30c), and is sealed against air from outside the barbecue grill 100.

In the structure in this embodiment, the support members 31 (30a, 30b, 30c) are plate-like (e.g., metal plate-like) and have an air-blocking function. The support members 31 provide an air-blocking function as long as closing the support portion space 20 on at least three sides (e.g., the left and right sides and the rear side). Therefore, the support members 31 may not include a front portion (door portion) 30c. In the case where the support members 31 are pillar-like, air-blocking members 31 (30a, 30b, 30c) may be additionally provided. Even in the case where the air-blocking members 31 (30a, 30b and 30c) included in the support members 31 do not directly secure the burner portion 10, the support members 31 including such air-blocking members 31 (30a, 30b and 30c) may be comprehensively referred to as “support members 31”.

The support portion space 20 in this embodiment accommodates the gas cartridges 52. In the example shown in FIG. 14, the gas cartridges 52 each have a structure shown in FIG. 10 (structure of a commercially available gas cartridge) and is filled with liquefied butane containing normal butane as a main component. The gas cartridges 52 are set in the support portion space 20 as being located in the gas cartridge unit 50 shown in FIG. 9. The gas cartridge unit 50 having the gas cartridges 52 accommodated therein is connected with the burner portion 10 via the gas hose 40. Namely, gas is supplied from the gas cartridge unit 50 via the gas hose 40 to the burner portion 10. Gas cartridges filled with liquefied butane containing iso-butane as a main component are also usable. However, the gas cartridges filled with normal butane are preferable in consideration of a technological or economic advantage.

In the support portion space 20, a fan 21 is located at a position 20a on the burner portion 10 side. The fan 21 is a ventilator (or absorber) supplying air 25 to the gas cartridges 52. The fan 21 in this embodiment absorbs air at the position 20a below the burner portion 10 (air heated by being burned) and supplies the absorbed air (heated air) to the gas cartridges 52 (see arrows 25).

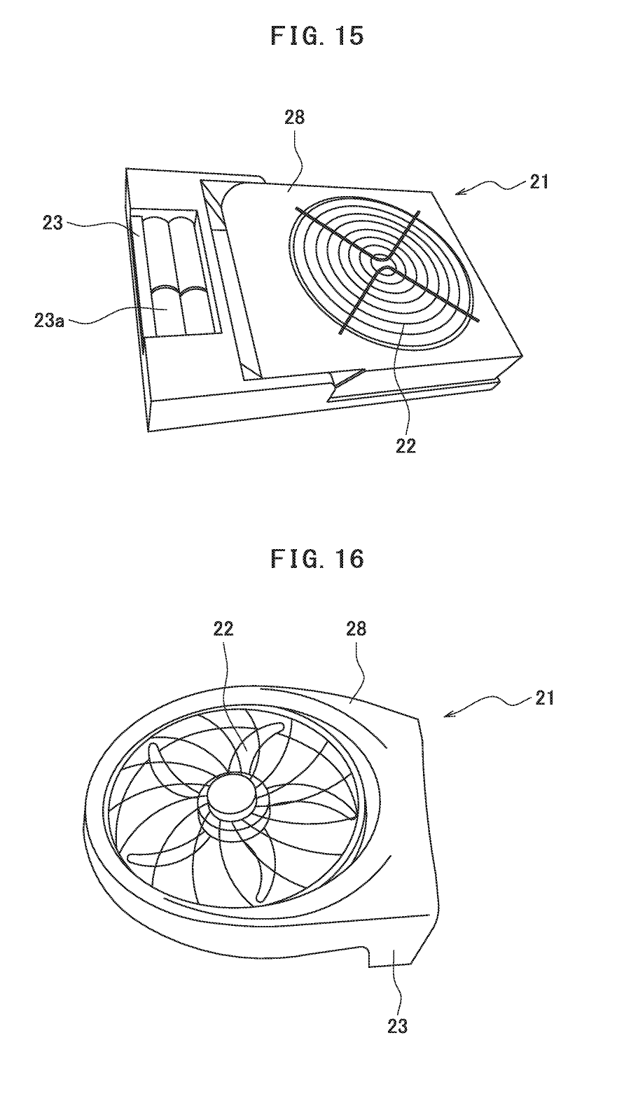

An example of the fan 21 in this embodiment is as shown in, for example, FIG. 15 or FIG. 16. The fan 21 shown in FIG. 15 is a battery-driven ventilator, and includes a blade portion 22 absorbing and supplying air and a housing 28 accommodating the blade portion 22. The housing 28 is connected with a power source 23 accommodating batteries 23a. The batteries 23a may be dry cells or rechargeable secondary cells.

The fan 21 shown in FIG. 16 includes a blade portion 22 absorbing and supplying air and a housing 28 accommodating the blade portion 22. The housing 28 has a power source 23 built therein. The power source 23 may allow dry cells to be mounted thereon or may be rechargeable (e.g., lithium secondary cell) like in a mobile phone. FIG. 15 and FIG. 16 both show the fan 21 including the blade portion 22. Alternatively, the fan 21 may not include blades. The fan 21 may not be battery-driven and may be operated as being connected with an electric outlet. The fan 21 of a battery-driven type is carried and set more easily. The fan 21 may be operable by a solar cell.

The fan 21 in this embodiment merely needs to have an ability of supplying air at the position 20a on the burner portion 10 side in the support portion space 20 to the gas cartridge unit 50. The fan 21 has an output of, for example, 3 W to 5 W. The output of the fan 21 is not limited to such a range, and may have an appropriate output. The fan 21 may have any size with no specific limitation as long as the fan 21 is set in the support portion space 20.

In the structure in this embodiment, the fan 21 is located above the gas cartridge unit 50 (gas cartridges 52). The position of the fan 21 may be appropriately set in accordance with the size and the performance of the barbecue grill 100 used. The distance between the fan 21 and the gas cartridges 52 (distance H1) is, for example, 30 cm to 40 cm. The distance between the fan 21 and a bottom surface of the burner portion 10 (distance H2) is, for example, 10 cm to 40 cm (typically, 20 cm to 30 cm). The distance between the gas cartridges 52 and the bottom surface of the burner portion 10 (distance H3) is, for example, 50 cm to 60 cm. The distance between the gas cartridges 52 and the gas burner 12 (distance H4) is, for example, 70 cm to 90 cm. These distances are examples, and the locations and the distances may be appropriately set to be preferable as long as the fan 21 has an ability of preventing the gas cartridges 52 from being cooled.

The fan 21 and the gas cartridge unit 50 (gas cartridges 52) in this embodiment may be secured to a part of the support portion 30 or may be located on a multi-stage accommodation member (e.g., rack) provided in the support portion space 20. In the case where the multi-stage accommodation member is used, the fan 21 may be located on a top stage so that an opening is provided below the fan 21 (e.g., opening formed of an array of rods and gaps). In this case, the air 25 from the fan 21 directly arrives at the gas cartridges 52. The gas cartridge unit 50 may be located on a middle stage or a bottom stage and the stages may have an appropriate distance therebetween. In this case, the locations of the fan 21 and the gas cartridge unit 50 (gas cartridges 52) (e.g., distances H1 through H4) may be set in a simple manner.

In the structure in this embodiment, the support members 31 (support portion 30) are connected with a base table 70 having wheels 71 and 72 attached thereto. The wheel 71, which is larger, is provided to move the barbecue grill 100, whereas the wheel 72, which is smaller, has a stopper function. The base table 70 has a propane cylinder accommodation portion 75 provided therein. In the propane cylinder accommodation portion 75, the propane cylinder (59) may be to be set. In this manner, the barbecue grill 100 is usable both with the gas cartridges 52 and the propane cylinder 59. In the case where only the gas cartridges 52 are to be used, the propane cylinder accommodation portion 75 does not need to be provided.

The burner portion 10 in this embodiment accommodates a plurality of the gas burners 12. The burner portion 10 is formed of a heat-resistant material (e.g., metal material) that is resistant against the heat provided by the gas burners 12. In this example, the gas burners (main burners) 12 have a straight shape. Three such gas burners 12 are extended parallel to the ground. Such gas burners 12 burn the gas supplied through the gas hose 40 connected with the gas cartridges 52. The power of the fire of each gas burner 12 is adjustable by the fire power dial 15. The gas burners 12 in this embodiment each have a double-tube structure formed of stainless steel, and each have an output of, for example, about 7 kW to 16 kW (preferably, 8 kW to 12 kW). There is no specific limitation on the type or the output of the gas burners 12. The gas burners 12 may be, for example, circular or annular. The gas burners 12 may each have a small output less than 5 kW or each have a large output of 20 kW or greater.

In the burner portion 10, a gridiron 61 on which a food material (90) may be placed is provided above the gas burners 12. The gridiron 61 in this embodiment is formed of a metal material (e.g., cast iron). A gridiron of cast iron may accommodate a large amount of heat by the weight thereof. The gridiron 61 in this embodiment has a structure by which when steak meat (90) is placed thereon and softly pressed from above, the steak meat (90) obtains a clear brown pattern as provided in a steakhouse. The gridiron 61 may have a mesh shape formed of straight metal portions and gaps between the straight metal portions or a lattice shape. A heat releasing plate (e.g., formed of stainless steel, preferably having a triangular wave-shaped cross-section) may be provided on the gas burners 12 in order to uniformly distribute the heat from the gas burners 12 to the entirety of the gridiron (grill portion) 61. The heat releasing plate also has a role of vaporizing, because of the high temperature, fat, gravy or the like fallen thereon to provide a wonderful barbecue flavor.

In the structure in this embodiment, the oven portion 60 covering the burner portion 10 is provided. The oven portion 60 in this embodiment is formed of cast aluminum (cast aluminum oven) and thus has a very high heat retaining ability and keeps the inner temperature thereof constant. Covering the gridiron 61 with the oven portion 60 creates a sealed state and thus provides a steaming effect. The oven portion 60 has the thermometer 65 attached thereto, the thermometer 65 showing the inner temperature of the oven portion 60. Thus, the temperature may be appropriately controlled and adjusted during cooking. The side tables 62 are coupled to the sides of the burner portion 10 to improve the efficiency of cooking. Side tables 62 are foldable when not in use.

Now, mainly with reference to FIG. 14, a method for using the barbecue grill 100 in this embodiment (method for operating, and method for cooking by use of, the barbecue grill 100) will be described.

First, the gas cartridge unit 50 is set in the support portion space 20 of the barbecue grill 100. Next, gas is supplied from the gas cartridge unit 50 and is burned by the gas burners 12 in the burner portion 10. The burning heats the food material (90) to advance cooking and also heats the bottom surface of the burner portion 10 and the air in the vicinity of the bottom surface.

As the liquefied gas in the gas cartridges 52 is vaporized, the temperature of the gas cartridges 52 becomes lower than room temperature (ambient temperature). In this embodiment, the heated air (air having a temperature higher than room temperature) is blown by the fan 21 toward the gas cartridges 52. Therefore, the cooling of the gas cartridges 52 is alleviated.

In an experiment performed by the present inventor, in the case where the fan 21 was not activated at an outdoor temperature of 9° C., the surface temperature of the gas cartridges 52 was decreased to 0.5° C. (decreased by 19.5° C. into a cooled state from 20° C. when the gas cartridges 52 were kept indoors) during the operation of the gas burners 12. In the case where the fan 21 was activated under the same conditions, the surface temperature of the gas cartridges 52 was increased to 5° C. (increased by 4.5° C. into a warmed state from the cooled state of 0.5° C.). Namely, it has been confirmed that the activation of the fan 21 allows the barbecue grill 100 supplied with gas from the gas cartridges 52 to be operated in a stable state. In the case where the fan 21 was not activated, the gas fire was extinguished within about 10 minutes to 15 minutes.

In the structure in this embodiment, the barbecue grill 100 using the gas cartridges 52 is stably operable at night or in a cold region. This promotes the spread of barbecue grills (heating cooking devices) and also increases the speed of spread of the custom of barbecuing. For example, even though a barbecue grill (heating cooking device) was installed in a balcony of an apartment, it was not possible to do a barbecue at night with a low temperature or in winter unless a propane cylinder was provided. By contrast, the barbecue grill 100 in this embodiment allows a barbecue to be done at any time, even at night with a low temperature or in winter, as long as a gas cartridges is purchased. A barbecue is also done outdoors even without a propane cylinder as long as a gas cartridge is purchased.

In the barbecue grill 100 in this embodiment, the gas cartridges 52 (gas cartridge unit 50) are accommodated in the support portion space 20 enclosed by the support portion 30 supporting the burner portion 10 accommodating the gas burners 12. At the position (20a) on the burner portion 10 side in the support portion space 20, the fan 21 is located. Therefore, the air heated by the gas burners 12 is caused to hit the gas cartridges 52 (gas cartridge unit 50) by the fan 21. Thus, the temperature of the gas cartridges 52, which are cooled by a heat of vaporization caused by release of butane gas, is increased. For this reason, the barbecue grill 100 using the gas cartridges 52 filled with liquefied butane gas is stably operable even in a low-temperature environment (e.g., in winter or at night).

In this embodiment, the air heated by the gas burners 12 is used to prevent the temperature of the gas cartridges 52 from being decreased (to increase the temperature of the gas cartridges 52), which is highly efficient. More specifically, an electric heater using generated electricity or a disposable heat pack is not used, but merely the fan 21, which is energy-saving, is used to put the heat generated during cooking (heated air) into contact with the gas cartridges 52. No energy is used for generating the heat, and thus there is no cost for generating the heat. This is highly economical. Merely operating the fan 21 during cooking does not require much time or labor and is highly convenient. The gas cartridges 52 are not directly heated but is warmed by the heated air. Therefore, the gas cartridges 52 are not excessively heated, which is highly advantageous in terms of safety.

The burner portion 10 of the barbecue grill 100 in this embodiment has a shape of a box having the top side opened and including the bottom surface. The gridiron 61 is located at the open top side (opening), and the gas burners 12 are located at a middle level of the burner portion 10. The bottom side of the burner portion 10 is closed by the bottom surface. The bottom surface of the gas burner portion 10 receives fat, moisture or the like falling from the food material (90) located on the gridiron 61 and thus prevents the fan 21 from being stained. In the structure in this embodiment, the gas burners 12 heat the bottom surface of the burner portion 10 (e.g., bottom plate formed of a metal material), and the bottom surface of the burner portion 10 heats the air in an area (20a) just below the bottom surface, namely, the air at the position above (just above) the fan 21 (position 20a). The heated air is caused by the fan 21 to flow in the space 20 enclosed by the air-blocking members (30a and the like) and thus to contact the gas cartridges 52. In the case where the burner portion 10 is open on the bottom side, there is a disadvantage that the fan 21 (and the gas cartridges 52) is stained. However, in the case where the burner portion 10 accommodates a mechanism or a member that traps fat or any other staining substance falling in the burner portion 10, the burner portion 10 may be open on the bottom side. In this case, the air heated by the gas burners 12 is absorbed into the fan 21 by the absorbing force of the fan 21 and is blown toward the gas cartridges 52.

The air-blocking members (30a through 30c) merely need to have an air-blocking function that is sufficient to keep the air blown from the fan 21 toward the gas cartridges 52. Therefore, the air-blocking members (30a through 30c) may have a small opening or gap or even an observation window or the like. In the case where the support portion 30 is rectangular or square as seen in a plan view, the support portion 30 provides an air-blocking function as long as being closed on at least three sides. In the case where the support portion 30 is circular (or elliptical, oval, elliptical with straight portions, etc.) or polygonal (hexagonal, octagonal, etc.) as seen in a plan view, the support portion 30 provides an air-blocking function as long as being closed over about 270 degrees.

The barbecue grill 3500 shown in FIG. 8 may have the structure in this embodiment as follows. The air-blocking members (30a through 30c) are located around the support rods 35 to enclose the space below the burner portion 10. The fan 21 is located above the gas cartridges 52 (gas cartridge unit 50). In other words, the fan 21 is located an area below the burner portion 10 and between the burner portion 10 and the gas cartridges 52 (gas cartridge unit 50). With such a structure, the fan 21 may be operated to warm the gas cartridges 52 (gas cartridge unit 50) cooled by a heat of vaporization.

Regarding the structure shown in FIG. 14, it may be presumed that even without the fan 21, the cooled gas cartridges 52 are warmed by putting the gas cartridges 52 close to the bottom surface of the burner portion 10. However, air is heat-insulating, and therefore, it is difficult to warm the gas cartridges 52 by heat transmission, not by ventilation. In addition, in the case where the gas cartridges 52 are heated by heat transmission, not by ventilation caused by the fan 21, the gas cartridges 52 may be excessively heated, which is not preferable.

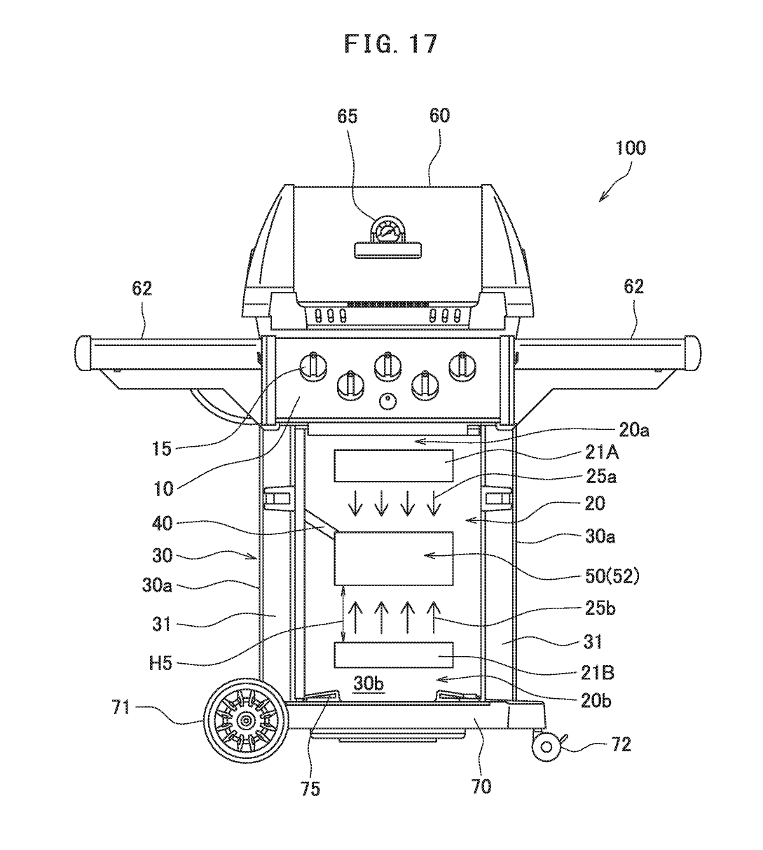

Now, with reference to FIG. 17, a modification of the barbecue grill 100 in this embodiment will be described. In the barbecue grill 100 shown in FIG. 14, the heated air is caused to hit, from above, the gas cartridges 52 (gas cartridge unit 50) by the ventilation caused by the fan 21. The heated air is not limited to being caused to hit the gas cartridges 52 in this manner. As shown in FIG. 17, a fan 21B may be located below the gas cartridges 52 (gas cartridge unit 50) so that the air is caused to hit, from below, the gas cartridges 52 (gas cartridge unit 50) by the fan 21B.

This will be described more specifically. In the barbecue grill 100 shown in FIG. 17, a first fan 21A is located above the gas cartridges 52 (gas cartridge unit 50) and the second fan 21B is located below the gas cartridges 52 (gas cartridge unit 50). A top surface of the gas cartridges 52 is heated by the first fan 21A (see arrows 25a) whereas a bottom surface of the gas cartridges 52 is heated by the second fan 21B (see arrows 25b).

The gas cartridges 52 are set in the gas cartridge unit 50 such that a nozzle (provided for absorbing gas from liquefied butane) located inside each gas cartridge 52 is on the bottom surface of the gas cartridge 52 (the tip portion 52b has a cut-out portion such that the gas cartridge 52 is set in this manner). Therefore, the cooling phenomenon caused by a heat of vaporization often occurs on the bottom side of the gas cartridges 52. For this reason, it is highly effective to heat the bottom surface of the gas cartridges 52 by the second fan 21B as shown in FIG. 17.

The second fan 21B (bottom fan) located in a bottom area 20b in the support portion space (closed space) 20 of the support portion 30 is far from the burner portion 10 accommodating the gas burners 12, but absorbs the heated air supplied from the first fan 21A (top fan) and supplies the heated air to the gas cartridges 52. The distance between the gas cartridges 52 and the second fan 21B (distance H5) is, for example, 5 cm to 15 cm. This distance is an example, and the location and the distance may be appropriately set to be preferable as long as the fan 21B has an ability of preventing the gas cartridges 52 from being cooled.

In an experiment performed by the present inventor, in the case where the first fan 21A and the second fan 21B were not activated at an outdoor temperature of 9° C., the surface temperature of the gas cartridges 52 was decreased to 0.5° C. (decreased by 19.5° C.) during the operation of the gas burners 12. In the case where the first fan 21A and the second fan 21B were activated under the same conditions, the surface temperature of the gas cartridges 52 was increased to 7° C. (increased by 6.5° C.). Namely, it has been confirmed that the activation of the first fan 21A and the second fan 21B allows the barbecue grill 100 supplied with gas from the gas cartridges 52 to be operated in a stable state.

The gas cartridges 52 are more cooled on the bottom side (and the internal nozzle for absorbing gas extends toward the bottom side). Therefore, the second fan 21B may be more positively used to warm the bottom side of the gas cartridges 52 more. In such a case, a partition plate, an air-blocking member or the like may be provided such that the heated air supplied by the first fan 21A flows toward the second fan 21B more easily.

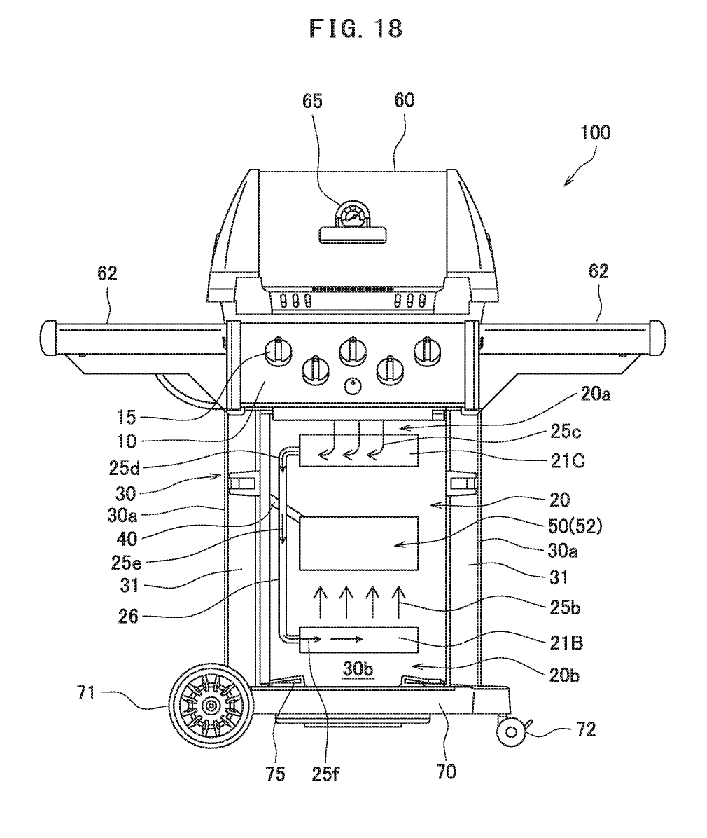

In a structure shown in FIG. 18, a fan 21C located in a top area is used as an absorbing fan. The air is supplied by the fan 21C to the fan 21B located in a bottom area via a duct (air duct) 26. In the example shown in FIG. 18, the top fan 21C does not cause the air to hit the gas cartridges 52, and only the bottom fan 21B causes the air to hit the gas cartridges 52 to warm the gas cartridges 52. This will be described more specifically. The heated air in the top area 20a (position 20a just below the burner portion 10) of the support portion space 20 is absorbed into the top fan 21C (arrows 25c) and is supplied to the duct 26 (arrow 25d). The heated air flows in the duct 26 (arrow 25e) to be supplied from the duct 26 to the bottom fan 21B (arrows 25f) and is blown toward the gas cartridges (arrows 25b) by the bottom fan 21B.

The present inventor made an experiment using gas cartridges filled with iso-butane (high power-type gas cartridges; Super Butane Gas Gold produced by Toho Metal Industries, Co., Ltd.) as well as the gas cartridges filled with normal butane. Without the fan 21, at a temperature of 8° C., the temperature (surface temperature on the top surface) of the gas cartridges (52) was 4° C. twenty minutes after the start of the experiment. At this point, the gas fire was significantly small and the temperature of the grill started to decrease. In the case where the first fan 21A (top fan 21A) was operated, the temperature of the gas cartridges (52) was 13° C. fifteen minutes after the start of the experiment. At this point, the temperature of the grill exceeded 300° C. Therefore, the gas fire was extinguished to finish the experiment. As can be seen, the method in this embodiment is effective for the gas cartridges (52) filled with iso-butane as well as the gas cartridges (52) filled with normal butane.

In the case where both of the first fan 21A and the second fan 21B (top fan 21A and bottom fan 21B) were operated, the temperature of the gas cartridges (52) was 13° C. ten minutes after the start of the experiment. Eleven minutes after the start of the experiment, the temperature of the grill exceeded 300° C. Therefore, the gas fire was extinguished to finish the experiment. In the case where both of the first fan 21A and the second fan 21B were operated and in the case where only the first fan 21A was operated, the temperature of the gas cartridges (52) was the same (13° C.). This is because the temperature of the top surface of the gas cartridges 52 was measured. The temperature of the bottom surface of the gas cartridges 52 was higher in the case where both of the first fan 21A and the second fan 21B were operated. This is reflected on the temperature of the grill (time required to reach 300° C.).

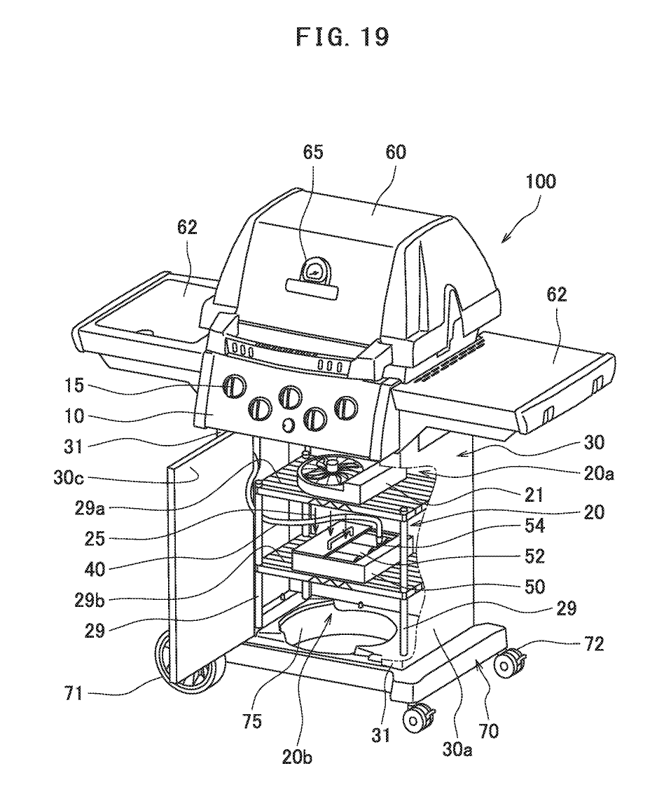

Now, with reference to FIG. 19 through FIG. 21, structures of barbecue grills 100 in an embodiment will be further described.

A barbecue grill 100 shown in FIG. 19 corresponds to the barbecue grill 100 shown in FIG. 14. In the structure shown in FIG. 19, a rack (multi-stage accommodation member) 29 is located in the support portion space 20 of the support portion 30. A top stage 29a of the rack 29 is formed of an array of linear members and gaps (openings), and has the fan 21 placed on a top surface thereof. The air 25 from the fan 21 (heated air) is blown toward the gas cartridges 52 (gas cartridge unit 50) through the gaps of the top stage 29a. In this example, the gas cartridge unit 50 is placed on a middle stage (or a bottom stage) 29b of the rack 29. The middle stage (or the bottom stage) 29b of the rack 29 is formed of an array of linear members and gaps, like the top stage 29a. However, this stage does not need to include the gaps.

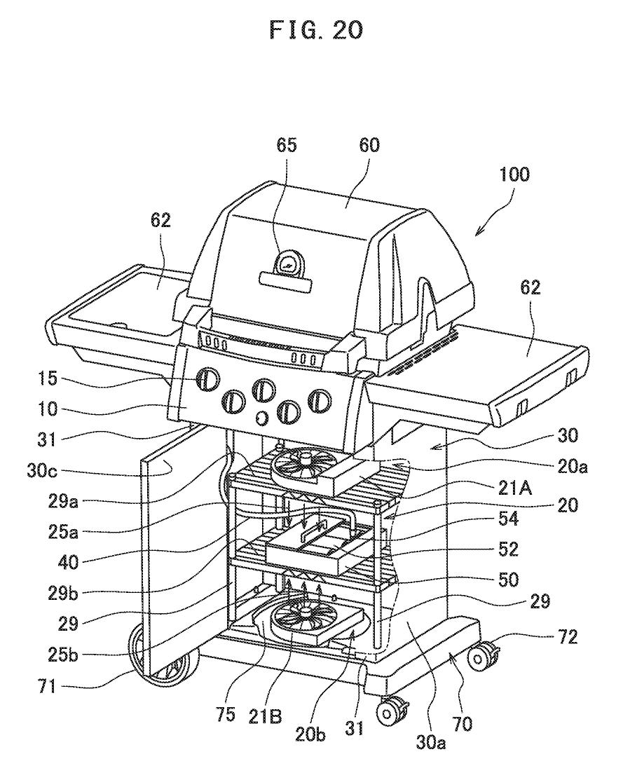

A barbecue grill 100 shown in FIG. 20 corresponds to the barbecue grill 100 shown in FIG. 17. In the structure shown in FIG. 20, a rack (multi-stage accommodation member) 29 is located in the support portion space 20 of the support portion 30. A top stage 29a of the rack 29 is formed of an array of linear members and gaps (openings), and has the top fan 21A placed on a top surface thereof. Air 25a from the top fan 21A (heated air) is blown toward the gas cartridges 52 (gas cartridge unit 50) through the gaps of the top stage 29a. The gas cartridge unit 50 is placed on a middle stage (or a bottom stage) 29b of the rack 29. The middle stage (or the bottom stage) 29b of the rack 29 is formed of an array of linear members and gaps, like the top stage 29a. Air 25b from the bottom fan 21B (heated air) is blown toward the gas cartridges 52 (gas cartridge unit 50) through the gaps of the middle stage 29b.

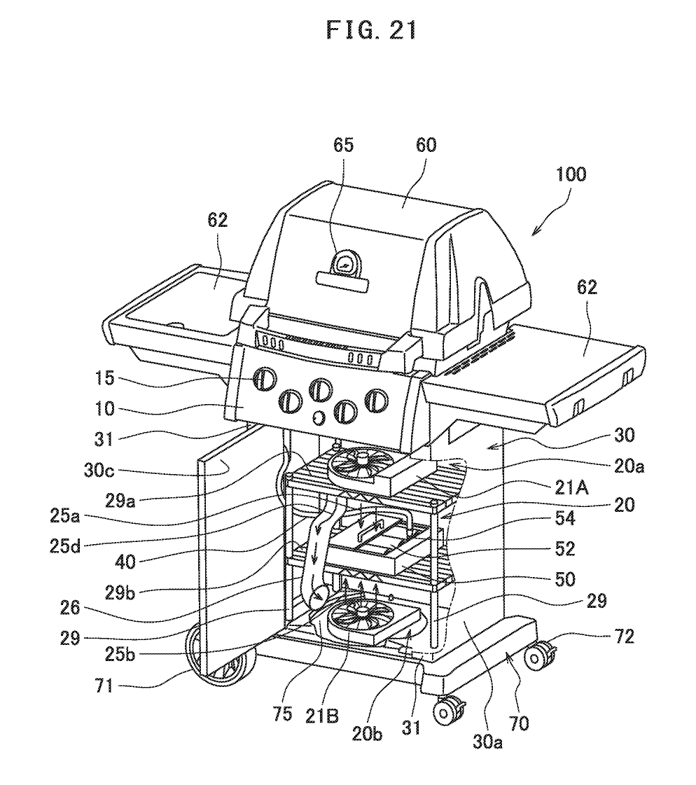

A barbecue grill 100 shown in FIG. 21 corresponds to the barbecue grill 100 shown in FIG. 18. In the structure shown in FIG. 21, a rack (multi-stage accommodation member) 29 is located in the support portion space 20 of the support portion 30. The duct (air guiding member) 26 guiding high-temperature air is also located in the support portions space 20. A top stage 29a of the rack 29 is formed of an array of linear members and gaps (openings), and has the fan 21A placed on a top surface thereof.

Air 25a from the fan 21A (heated air) is blown toward the gas cartridges 52 (gas cartridge unit 50) through the gaps of the top stage 29a (arrows 25a). The air absorbed by the top fan 21A (heated air) is supplied to the air guiding member (duct) 26 (arrow 25d). The gas cartridge unit 50 is placed on a middle stage (or a bottom stage) 29b of the rack 29. The middle stage (or the bottom stage) 29b of the rack 29 is formed of an array of linear members and gaps, like the top stage 29a. Air 25b from the bottom fan 21B (heated air) is blown toward the gas cartridges 52 (gas cartridge unit 50) through the gaps of the middle stage 29b. The bottom fan 21B blows the air in the vicinity thereof toward the gas cartridges 52 and also blows the air supplied through the air the duct 26 to the gas cartridges 52 (arrows 25b).

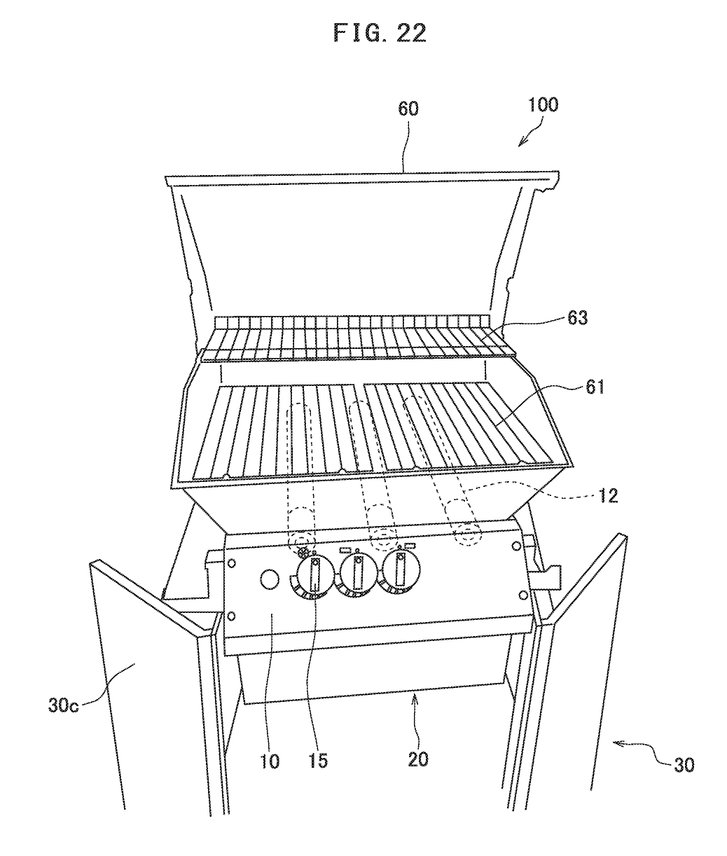

FIG. 22 shows an example of barbecue grill 100 in an embodiment in the state where the oven portion 60 is opened. The barbecue grill 100 shown in FIG. 22 has a different number of the fire power dials 15 from, but basically has the same structure as that of, the barbecue grill 100 shown in FIG. 14.

The structure of the barbecue grill 100 in this embodiment is operated as follows. When the gas burners 12 accommodated in the burner portion 10 are turned on, a gas fire rises toward the gridiron (food material placing portion) 61 located above the gas burners 12. On the gridiron 61, the food material (meat, etc.) 90 is placed and is cooked (grilled) by the gas fire. Inside the oven portion 60, the second gridiron (food material placing portion) 63 is provided. On the second gridiron 63, a grilled food material may be placed, a food material that is not wished to be grilled too much may be placed, or a food material to be steamed in the oven portion 60 may be placed. A heating target to be heated (food material) 90 placed on the gridiron 61 in this embodiment is typically food, for example, meat (beef, pork, chicken, etc.), a marine product (fish, Crustacea, Mollusca, shellfish, seaweed, etc.), vegetable, fruit or the like. The heating target may be pizza, bread, baked potato, or pastry (baked pastry, etc.). With the barbecue grill 100 in this embodiment, such a cooked item (grilled/baked item) is produced.

The fan 21 and the gas cartridge unit 50 are located in the support portion space 20 below the burner portion 10, and operate as described above. As the gas cartridges 52 to be set in the gas cartridge unit 50, many unused gas cartridges may be easily prepared. Therefore, it is not necessary to be concerned that the barbecue grill 100 may be short of fuel in the middle, unlike in the case where the propane cylinder 59 is used. Even when the door portion 30c of the support portion 30 is open, the support portion 30 is closed on three sides. Therefore, the air-blocking function is exerted on the support portion space 20. Thus, even in the state where the door portion 30c is open, the fan 21 and the gas cartridge unit 50 may be operated.

The above description on the barbecue grill 100 mainly regards the heating devices (heating cooking device) usable to do a barbecue. The gas cartridges 52 and the gas cartridge unit 50 accommodating the gas cartridges 52 are applicable to a heating cooking device with no oven portion 60. In the structure in this embodiment, the gas cartridge unit may be the gas cartridge unit 50 shown in FIG. 9 or the gas cartridge unit 50 shown in FIG. 11.

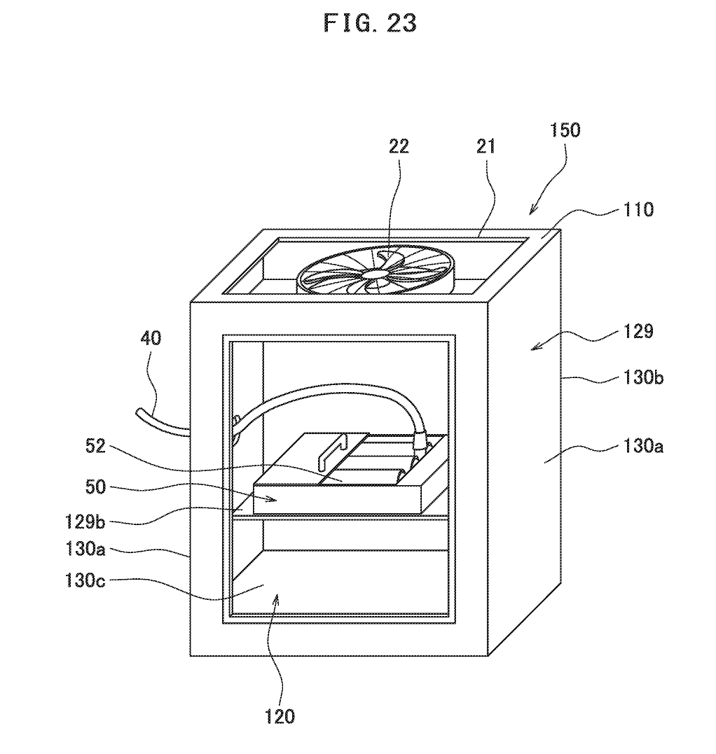

In the above description, the fan 21 is attached to the support portion 30 of the barbecue grill 100. Alternatively, the fan 21 may be attached to the gas cartridge unit 50. FIG. 23 shows a gas cartridge box 150 accommodating the fan 21. The fan 21 is a ventilator including a blade portion 22, and is located on a top surface of a housing 129 included in the gas cartridge box 150. The fan 21 may blow air toward the gas cartridge unit 50 (gas cartridges 52).

The gas cartridge box 150 includes air-blocking members (130a, 130b). In the example shown in FIG. 23, the housing 129 of the gas cartridge box 150 includes the air-blocking members. A portion 130c located on one surface of the housing 129 (e.g., front surface) may be a door portion or a transparent member (formed of glass or a transparent plastic material) or may be opened (may be an opening). Alternatively, the portion 130c may have the same structure as that of the other members (130a, 130b). The inside of the housing 129 is a closed space 120, and the gas cartridge unit 50 (and the gas hose 40) is located in the closed space 120. The gas cartridge unit 50 is placed on a table plate 129b. The gas hose 40 connected with the gas cartridge unit 50 extends outside from the inside of the housing 129.

The gas cartridge box 150 may be located, for example, below the burner portion 10 of the heating cooking device (barbecue grill) 3500 shown in FIG. 8. In such a case, the method in this embodiment is carried out with no substantial change, which is convenient. The gas cartridge box 150 in this embodiment allows the gas cartridges 52, instead of the propane cylinder 59, to be used for an oven using gas (gas burning-type heating device) in a cold region, and thus is highly convenient. The gas cartridge box 150 shown in FIG. 23 may be modified to include a plurality of the fans 21 (see FIG. 14, FIG. 15 or the like). The gas cartridge box 150 may be located in the space 20 in the support portion 30 of the barbecue grill 100 shown in FIG. 14 or the like. The gas cartridge unit 50 as shown in FIG. 11 may be used.

In this embodiment, one fan 21 is provided, or two fans 21 are respectively provided in a top part and a bottom part. The number of the fans 21 is not limited to any of these, and any other number of fans may be provided. In the structure in this embodiment, the heated air located just below the burner portion 10 is caused to hit the gas cartridges 52 by the fan 21. The air heated by the gas burners 12 is present in an area other than just below the burner portion 10. An air guiding member such as a duct or the like may be used to cause the air (heated air) in an area other than just below the burner portion 10 to hit the gas cartridges 52. However, such a structure is complicated. The structure as shown in FIG. 14 is preferable.

A thermometer may be located in the gas cartridges 52 (gas cartridge unit 50, gas cartridge box 150) to display the temperature of the gas cartridges 52 in real time. Heating the gas cartridges 52 by an electric heater wastes power and tends to excessively increase the temperature of the gas cartridges 52, and thus is not preferable. However, while the method in this embodiment is used to warm the gas cartridges 52, an electric heater may be used as an assisting member to control the temperature. The present invention does not eliminate such a use of an electric heater for the following reasons. Such temperature control is to heat in an assisting manner and thus does not consume much power, and it is preferable to positively control the temperature of the gas cartridges 52.

The gas cartridge box 150 shown in FIG. 23 may be modified as follows. The inner space 120 of the housing 129 shown in FIG. 23 is made a closed space (sealed space), and a heater (heating device) is provided inside the housing 129 (in the inner space 120). Air (inner air) heated by the heater (heating device) is internally circulated by a fan (ventilator) located inside the housing 129 (in the inner space 120). The circulating heated air warms the cooled gas cartridges 52 (gas cartridge unit 50). In the case where this system is adopted, it is preferable to provide a temperature sensing switch to control the temperature inside the housing 129 (in the inner space 120) in order to prevent excessive heating from being done by the heater. Typically, the warming switch may be configured to be turned on at a lower limit temperature (e.g., 20° C. or lower) and to be turned off at an upper limit temperature (e.g., 30° C.). In this manner, the gas cartridges 52 may be kept warmed safely.

The present inventor also performed an experiment on a gas cartridge box accommodating the gas cartridge unit 50, in which the gas cartridges 52 are set. The gas cartridge box 150 shown in FIG. 23 has substantially the same structure as that of the support portion 30 of the barbecue grill (heating cooking device) 100 in this embodiment shown in FIG. 14. Namely, the gas cartridge box 150 allows the heated air to be supplied by the fan (22) into the closed space 120 (or substantially closed space) formed by the air-blocking members (130a, 130b). Thus, the heated air is supplied by the fan 22 into the closed space 120, and the cooled gas cartridges 52 (gas cartridge unit 50) is warmed by the heat of the heated air. For this reason, the experiment made on the gas cartridge box 150 provides the same results as those of the experiment made on the barbecue grill 100 shown in FIG. 14 (or substantially the same results although the results vary in accordance with the conditions).

In order to investigate the effect provided by elements other than the gas cartridge box 150 shown in FIG. 23, the present inventor made experiments on the effect provided by the closed space 120 formed by the air-blocking members (130a, 130b) (or the effect provided in the absence of the closed space 120 formed by the air-blocking members (130a, 130b)) and also on the effect provided in the case where a heater is located in the closed space 120.

### Example 1

In an example in which the closed space 120 formed by the air-blocking members (130a, 130b) is absent (example 1), a burning experiment (experiment on the temperature change of the gas cartridges 52) was performed on the following structure. In the state where the hose 40 was connected with the burner portion 10, the gas cartridge unit 50 was located to the side of the support portion 30 having the structure shown in FIG. 14 or FIG. 19 (i.e., outside the support portion space (closed space) 20). The gas cartridge unit 50 shown in FIG. 9 was used. Three gas cartridges 52 were accommodated in the gas cartridge unit 50. The surface temperature of the bottom surface of each gas cartridge 52 was measured by a thermometer. The outdoor temperature was also measured by the thermometer.

In this experiment (example 1), at the time of ignition (0 minute), the outdoor temperature was 24° C., and the temperature (bottom surface temperature) of the gas cartridges 52 was 24° C. Five minutes after the ignition (the outdoor temperature was 24° C.), the temperature (bottom surface temperature) of the gas cartridges 52 was 24° C., like when the experiment was started. However, 10 minutes after the ignition (the outdoor temperature was 24° C.), the temperature (bottom surface temperature) of the gas cartridges 52 was 22° C. After this (after a lapse of 10 minutes from the ignition), the temperature started to be decreased gradually. Fifteen minutes after the ignition (the outdoor temperature was 24° C.), the temperature (bottom surface temperature) of the gas cartridges 52 was 18° C. Twenty minutes after the ignition (the outdoor temperature was 24° C.), the temperature (bottom surface temperature) of the gas cartridges 52 was 15° C. Fifteen minutes after the ignition, the vaporization speed of the gas was decreased to attenuate the vigor of the flame. Twenty minutes after the ignition, a sufficient level of fire power was not provided. Twenty minutes after the ignition, the temperature of the gas cartridges 52 was decreased by about 10° C. as compared with the temperature at the time of ignition.

It has been found from the results of this experiment (example 1) that even under the condition that the outdoor temperature exceeds 20° C. (e.g., 21° C. to 25° C.), a sufficient level of fire power is not provided when the gas cartridges 52 were used (especially as being connected with a barbecue grill). This is why it is common to use propane gas positively. It has been reconfirmed that especially in a season with a low temperature (especially, autumn to winter or winter to spring), the gas cartridges 52 filled with liquefied butane (especially, the gas cartridge filled with liquefied normal butane) have a low value of use.

### Example 2

Next, the present inventor performed an experiment on the following structure. In the state where the gas cartridges 52 were located to the side of the support portion 30 having the structure shown in FIG. 14 or FIG. 19 (i.e., outside the support portion space (closed space) 20), a fan (second fan 21B) was located below the gas cartridges 52. Air (outdoor air) was blown toward the bottom surface of the gas cartridges 52 from below. The air (outdoor air) used here was not heated by the burner portion 10, but was the air having the same temperature as the outdoor temperature (natural air). In this experiment (example 2), the rack 29 having the structure shown in FIG. 20 (in other words, the structure 29 having the gas cartridges 52 (or the gas cartridge unit 50) placed thereon) was set outside (to the side of) the support portion 30. The top fan (first fan) 21A was not provided, but the bottom fan (second fan) 21B was located below the gas cartridge unit 50.

In this experiment (example 2), at the time of ignition (0 minute), the outdoor temperature was 23° C., and the temperature (bottom surface temperature) of the gas cartridges 52 was 23° C. Five minutes after the ignition, the temperature of the gas cartridges 52 was 21° C., almost like when the experiment was started. Ten minutes after the ignition, the temperature of the gas cartridges 52 was 20° C. Fifteen minutes after the ignition, the temperature of the gas cartridges 52 was 19° C. Twenty minutes after the ignition, the temperature of the gas cartridges 52 was 19° C. The air from the bottom fan 21B was caused to hit the gas cartridges 52 (bottom surface of the gas cartridges 52), and thus the temperature decrease of the gas cartridges 52 was made significantly milder as compared with in example 1. No notable decrease in the fire power was seen.

It has been found from the results of this experiment (example 2) that in the case where the outdoor temperature is sufficiently high (e.g., 20° C. or higher), the gas in the gas cartridges 52 may be stably vaporized by use of outdoor air, with no use of air heated by a heat source (heat of the burner portion 10, or heat of an especially prepared heater). It should be noted that when the outdoor temperature is lower than 15° C., it is expected to be difficult to provide stable burning of the gas in the gas cartridges 52.

### Example 3

Next, the present inventor performed an experiment on the following structure. The gas cartridge unit 50 in a sealed state was located to the side of the support portion 30 (i.e., outside the support portion space (closed space) 20) having the structure shown in FIG. 14. Namely, a structure obtained as a result of the fan 22 being removed from the structure shown in FIG. 23 was used. In this example, the gas cartridge unit 50 was located in a cardboard box, and the cardboard box was sealed. A heater and a thermostat were located in the cardboard box, and the air inside the cardboard box was heated by the heater. The thermostat was set to a temperature of 26° C. No fan was located inside the box. Regarding the inner temperature of the box, the temperature at a middle level in the inner space of the box was measured.

In this experiment (example 3), at the time of ignition (0 minute), the inner temperature of the box was 23° C. (the outdoor temperature was 22° C.), and the temperature (bottom surface temperature) of the gas cartridges 52 was 23° C. Five minutes after the ignition, the inner temperature of the box was 28° C., and the temperatures of the three gas cartridges 52 were respectively 18° C., 19° C. and 20° C. Ten minutes after the ignition, the inner temperature of the box was 35° C., and the temperatures of the gas cartridges 52 were respectively 12° C., 13° C. and 16° C. Fifteen minutes after the ignition, the inner temperature of the box was 39° C., and the temperatures of the gas cartridges 52 were respectively 9° C., 9° C. and 13° C. After this, the experiment was not performed because the fire power was too weak.

It has been found from the results of this experiment (example 3) that unless the air in the box is circulated by the fan, the temperature of the gas cartridges 52 drastically decreases even though the inner space of the box is warmed by the heater. A reason for this is that the state of circulation of the air inside the box is significantly poor. Thus, although the temperature at a middle level of the inner space of the box keeps on increasing, the temperature of the gas cartridges 52 is decreased more drastically than when the gas cartridges 52 are exposed to the outdoor air. For this reason, the gas in the gas cartridges 52 was not burned stably.

### Example 4

Next, the present inventor performed an experiment as follows. Under the conditions of the experiment in example 3, a fan was located in the box and the air inside the box was circulated. The fan was located to the side of the gas cartridge unit 50, not below the gas cartridge unit 50. More specifically, in the structure shown in FIG. 23, a cardboard box was used as the box, and the gas cartridge unit 50 was placed in the box. A heater and a thermostat were also placed in the box, and the box was sealed. The thermostat was set to a temperature of 26° C., like in example 3.

In this experiment (example 4), at the time of ignition (0 minute), the inner temperature of the box was 23° C. (the outdoor temperature was 21° C.), and the temperature (bottom surface temperature) of the gas cartridges 52 was 22° C. Five minutes after the ignition, the inner temperature of the box was 25° C., and the temperatures of the three gas cartridges 52 were respectively 22° C., 22° C. and 22° C. Ten minutes after the ignition, the inner temperature of the box was 24° C., and the temperatures of the gas cartridges 52 were respectively 18° C., 18° C. and 18° C. Fifteen minutes after the ignition, the inner temperature of the box was 24° C., and the temperatures of the gas cartridges 52 were respectively 16° C., 18° C. and 17° C.

It has been found from the results of this experiment (example 4) that in the case where the air in the box is circulated by the fan, the heat from the heater is uniformly distributed in the box and there is no temperature difference in the box. It has also been found that the temperature decrease of the gas cartridges 52 is made milder, and the gas cartridges 52 are warmed by warm air generated by the heat from the heater (and by the warm air circulating by the fan).

In the experiment in example 4, the temperature of the thermostat may be increased to further stabilize the temperature of the gas cartridges 52. This system (system of locating a heater and a fan in a sealed box) allows the gas to be vaporized stably without being influenced by the outdoor temperature. The gas cartridges 52 are prohibited from being used at a high temperature of 40° C. or higher. It is presumed that a sufficiently stable burning effect is provided in the case where the inner temperature of the box is kept at 30° C. or lower.

The present invention has been described by way of preferable embodiments. The above description does not limit the present invention in any way, and the present invention may be modified in any of various manners.

### INDUSTRIAL APPLICABILITY

The present invention provides a barbecue grill stable operable at a low temperature while using a gas cartridge.

### DESCRIPTION OF REFERENCE CHARACTERS

10 Burner portion
12 Gas burner
15 Fire power dial
20 Support portion space
20a Top area
20b Bottom area
21 Fan
21A Top fan
21B Bottom fan
21C Absorbing fan
22 Blade portion
26 Duct
28 Housing
29 Rack (multi-stage accommodation member)
30 Support portion
31 Support member
35 Support rod
40 Gas hose
50 Gas cartridge unit
52 Gas cartridge
54 Gas exit
55 Gas amount adjusting dial
56 Gas hose connection portion
58 Coupling portion
59 Propane cylinder
60 Oven portion
61 Gridiron
62 Side table
63 Second gridiron
65 Thermometer
67 Portable oven
70 Base table
71 Moving wheel
72 Fixing wheel
75 Propane cylinder accommodation portion
90 Food material (heating target)
99 Vertical direction (upward/downward direction)
100 Barbecue grill
150 Gas cartridge box
1000 Barbecue grill
2000 Barbecue grill
3000 Barbecue grill
3500 Barbecue grill
4000 Portable oven (tabletop portable oven)
4400 Gas fire
4500 Gas cartridge accommodation portion
4600 Heat transmitting member

1. A barbecue grill grilling a food material, comprising:
a gas hose connected with a gas cartridge filled with liquefied butane containing normal butane as a main component;
a burner portion accommodating a gas burner burning gas supplied through the gas hose;
a support portion located below the burner portion, the support portion supporting the burner portion; and
an oven portion located above the burner portion, the oven portion covering the burner portion;
wherein:
the support portion includes:
a support member securing the burner portion; and
a support portion space enclosed by the support member;
the support portion space accommodates the gas cartridge; and
a fan supplying air to the gas cartridge is located at a position on the side of the burner portion in the support portion space.

2. The barbecue grill according to claim 1, wherein:
the fan is a battery-driven ventilator; and
the support portion space is a closed space enclosed by the support member.

3. The barbecue grill according to claim 1, wherein:
the gas cartridge is set in a gas cartridge unit allowing a plurality of the gas cartridges to be accommodated therein;
the gas hose is connected with the gas cartridge unit; and
the fan is located above the gas cartridge unit.

4. The barbecue grill according to claim 1, wherein a second fan supplying air to the gas cartridge is located below the gas cartridge in the support portion space.

5. The barbecue grill according to claim 4, wherein an air guiding member allowing air to be supplied to the second fan by ventilation of the fan is located in the support portion space.

6. The barbecue grill according to claim 1, wherein the support member enclosing the support portion space includes a metal plate and a door portion.

7. The barbecue grill according to claim 1, wherein:
the support member is connected with a base table provided with a wheel;
a propane cylinder accommodation portion allowing a propane cylinder to be set therein is provided in the base table;
the burner portion accommodates a plurality of the gas burners;
a gridiron on which the food material is to be placed is provided above the burner portion;
the gridiron is put into a sealed state by being covered with the oven portion;
the oven portion has a thermometer attached thereto, the thermometer indicating an inner temperature of the oven portion;
the burner portion including the gridiron is connected with a side table; and
the fan and the gas cartridge are located on a rack provided in the support portion space.

8. A cooking method using a barbecue grill, the barbecue grill being a burning device burning gas from a gas cartridge filled with liquefied butane; the method comprising the steps of:
burning the gas by the barbecue grill;
heating a food material by the burning; and
blowing air heated by the burning toward the gas cartridge cooled by a heat of vaporization.

9. The cooking method according to claim 8, wherein:
the barbecue grill includes a burner portion including a gas burner burning the gas;
in the step of blowing, the air heated by the burning is located below the burner portion; and
the heated air is caused to hit the gas cartridge by a fan.

10. The cooking method according to claim 9, wherein:
a closed space enclosed by a support member is located below the burner portion;
the gas cartridge is located in the closed space; and
the heated air moves in the closed space to contact the gas cartridge.

11. The cooking method according to claim 8, wherein the step of blowing is performed by a first fan located above the gas cartridge and a second fan located below the gas cartridge.

12. The cooking method according to claim 8, wherein:
the gas cartridge is filled with liquefied gas containing normal butane as a main component;
the gas cartridge is set in a gas cartridge unit allowing a plurality of the gas cartridges to be accommodated therein; and
in the step of burning the gas by the barbecue grill, the gas is supplied to the barbecue grill from the gas cartridge unit via a gas hose.

13. A heating cooking device grilling a food material, comprising:
a gas cartridge unit accommodating a gas cartridge filled with liquefied butane;
a burner portion located above the gas cartridge unit, the burner portion burning gas vaporized from the liquefied butane; and
a support portion located below the burner portion, the support portion supporting the burner portion;
wherein:
a fan is located between the burner portion and the gas cartridge unit;
the support portion includes an air-blocking member;
the gas cartridge unit and the fan are enclosed by the air-blocking member; and
the fan is a ventilator blowing air toward the gas cartridge unit.

14. The heating cooking device according to claim 13, wherein a second fan is located below the gas cartridge unit.

15. The heating cooking device according to claim 14, wherein:
the fan is an absorbing fan absorbing air in the vicinity thereof; and
the fan is provided with a duct allowing the absorbed air to be supplied to the second fan.

16. A method for producing a grilled product by burning gas, the method comprising the steps of:
burning, by a gas burner, gas supplied from a gas cartridge filled with liquefied butane;
heating a heating target by the burning by the gas burner; and
blowing air heated by the burning toward the gas cartridge cooled by a heat of vaporization.

17. The method for producing a grilled product according to claim 16, wherein:
in the step of blowing, the air heated by the burning is located below the gas burner; and
the heated air is caused to hit the gas cartridge by a fan; and
an air-blocking member is located in the vicinity of the gas cartridge.
